(19) United States
(12) Patent Application Publication
(10) Pub. No.: US 2025/0351184 A1
(43) Pub. Date: Nov. 13, 2025

(54) PREAMBLE-BASED IDENTIFICATION OF COMMON BEAMS

(71) Applicant: QUALCOMM Incorporated, San Diego, CA (US)

(72) Inventors: Ahmed Attia Abotabl, San Diego, CA (US); Navid Abedini, Basking Ridge, NJ (US)

(21) Appl. No.: 18/660,957

(22) Filed: May 10, 2024

(51) Int. Cl. H04W 74/0833; H04B 17/318; H04W 74/08

(52) U.S. Cl. CPC H04W 74/0833; H04B 17/328; H04W 74/0891

(57) ABSTRACT

This disclosure provides systems, methods, and apparatuses, including computer programs encoded on computer storage media, for wireless communication. In one aspect of the disclosure, a network entity transmits random access channel (RACH) configuration messages indicating physical RACH (PRACH) preambles associated with synchronization signal blocks (SSBs) in which at least one of the PRACH preambles is associated with two or more SSBs. User equipments (UEs) determine one or more suitable beams according to signal quality measurements of SSBs received on respective beams and select a PRACH preamble according to the SSBs having suitable signal quality measurements. The UEs transmit the selected preamble to the network entity, which may then select a common beam for downlink communication to the UEs according to common beams associated with the received preambles. Other aspects and features are also claimed and described.

### TECHNICAL FIELD

Aspects of the present disclosure relate generally to wireless communication systems, and more particularly, to preamble-based identification of common beams.

### DESCRIPTION OF THE RELATED TECHNOLOGY

Wireless communications systems are widely deployed to provide various types of communication content such as voice, video, packet data, messaging, broadcast, and so on. A wireless multiple-access communications system may include a number of network entities, such as base stations or network access nodes, each simultaneously supporting communication for multiple communication devices, which may be otherwise known as user equipment (UE). These systems may be capable of supporting communication with multiple UEs by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

As the demand for mobile broadband access continues to increase, the possibilities of interference and congested networks grows with more different types of UEs accessing the long-range wireless communication networks in greater numbers and more short-range wireless systems being deployed in communities. For example, the signaling overhead to efficiently manage communications between the increasing volume of UEs and the deployed wireless communications networks adds to the growing congestion of available network resources, thus, potentially diminishing the user experience and communications efficiency. Research and development continue to advance wireless technologies not only to meet the growing demand for mobile broadband access, but to advance and enhance the user experience with mobile communications.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One innovative aspect of the subject matter described in this disclosure can be implemented in a network entity. The network entity includes a processing system that includes processor circuitry and memory circuitry that stores code. The processing system is configured to cause the network entity to transmit one or more random access channel (RACH) configuration messages indicating a plurality of physical RACH (PRACH) preambles associated with a plurality of synchronization signal blocks (SSBs), each SSB of the plurality of SSBs being associated with a respective beam of a plurality of beams, one or more PRACH preambles of the plurality of PRACH preambles each being associated with two or more SSBs of the plurality of SSBs. The processing system is further configured to transmit the plurality of SSBs on respective beams of the plurality of beams and receive a RACH message from a first user equipment (UE) that includes a first PRACH preamble from the one or more PRACH preambles, the first PRACH preamble associated with a respective set of two or more SSBs and indicating that each beam associated with each SSB of the respective set of two or more SSBs is acceptable.

Another innovative aspect of the subject matter described in this disclosure can be implemented in a method performed by a network entity. The method includes transmitting one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs. The method further includes transmitting the plurality of SSBs on respective beams of the plurality of beams and receiving a RACH message from a first UE that includes a first PRACH preamble from the one or more PRACH preambles, the first PRACH preamble associated with a respective set of two or more SSBs and indicating that each beam associated with each SSB of the respective set of two or more SSBs is acceptable.

Another innovative aspect of the subject matter described in this disclosure can be implemented in a network entity. The network entity includes means for transmitting one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs. The network entity further includes means for transmitting the plurality of SSBs on respective beams of the plurality of beams and means for receiving a RACH message from a first UE that includes a first PRACH preamble from the one or more PRACH preambles, the first PRACH preamble associated with a respective set of two or more SSBs and indicating that each beam associated with each SSB of the respective set of two or more SSBs is acceptable.

Another innovative aspect of the subject matter described in this disclosure can be implemented in a non-transitory computer-readable medium storing instructions that, when executed by a processor at a network entity, cause the processor to perform operations including transmitting one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs. The instructions further cause the processor to perform operations including transmitting the plurality of SSBs on respective beams of the plurality of beams and receiving a RACH message from a first UE that includes a first PRACH preamble from the one or more PRACH preambles, the first PRACH preamble associated with a respective set of two or more SSBs and indicating that each beam associated with each SSB of the respective set of two or more SSBs is acceptable.

Another innovative aspect of the subject matter described in this disclosure can be implemented in a UE. The UE includes a processing system that includes processor circuitry and memory circuitry that stores code. The processing system is configured to cause the UE to receive one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs. The processing system is further configured to receive at least some of the plurality of SSBs on respective beams of the plurality of beams and transmit a RACH message that includes a first PRACH preamble from the first set of one or more PRACH preambles associated with a respective set of two or more SSBs, the first PRACH preamble indicating that each beam associated with each SSB of the respective set of two or more SSBs is acceptable.

Another innovative aspect of the subject matter described in this disclosure can be implemented in a method executed by a UE. The method includes receiving one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs. The method further includes receiving at least some of the plurality of SSBs on respective beams of the plurality of beams and transmitting a RACH message that includes a first PRACH preamble from the first set of one or more PRACH preambles associated with a respective set of two or more SSBs, the first PRACH preamble indicating that each beam associated with each SSB of the respective set of two or more SSBs is acceptable.

Another innovative aspect of the subject matter described in this disclosure can be implemented in a UE. The UE includes means for receiving one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs. The UE further includes means for receiving at least some of the plurality of SSBs on respective beams of the plurality of beams and means for transmitting a RACH message that includes a first PRACH preamble from the first set of one or more PRACH preambles associated with a respective set of two or more SSBs, the first PRACH preamble indicating that each beam associated with each SSB of the respective set of two or more SSBs is acceptable.

Another innovative aspect of the subject matter described in this disclosure can be implemented in a non-transitory computer-readable medium storing instructions that, when executed by a processor at a UE, cause the processor to perform operations including receiving one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs. The instructions further cause the processor to perform operations including receiving at least some of the plurality of SSBs on respective beams of the plurality of beams and transmitting a RACH message that includes a first PRACH preamble from the first set of one or more PRACH preambles associated with a respective set of two or more SSBs, the first PRACH preamble indicating that each beam associated with each SSB of the respective set of two or more SSBs is acceptable.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system that supports preamble-based identification of common beams according to one or more aspects.

FIG. 4 is a flow diagram illustrating an example process executable at a UE that supports preamble-based identification of common beams according to one or more aspects.

FIG. 5 is a flow diagram illustrating an example process executable at a network entity that supports preamble-based identification of common beams according to one or more aspects.

FIG. 6 is a block diagram illustrating an example wireless network including a network entity and multiple UEs, each of which supports preamble-based identification of common beams according to one or more aspects.

FIG. 7 is a block diagram illustrating an example wireless network including a network entity and multiple UEs, each of which supports preamble-based identification of common beams according to one or more aspects.

FIG. 8 is a block diagram illustrating an example wireless network including a network entity and multiple UEs, each of which supports preamble-based identification of common beams according to one or more aspects.

FIG. 9 is a block diagram illustrating an example wireless network including a network entity and multiple UEs, each of which supports preamble-based identification of common beams according to one or more aspects.

FIG. 10 is a block diagram illustrating an example wireless network including a network entity and multiple UEs, each of which supports preamble-based identification of common beams according to one or more aspects.

FIG. 11 is a block diagram illustrating an example UE that supports preamble-based identification of common beams according to one or more aspects.

FIG. 12 is a block diagram illustrating an example network entity that supports preamble-based identification of common beams according to one or more aspects.

Like reference numbers and designations in the various drawings indicate like elements.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Various aspects of the present disclosure relate to techniques that enable a UE to implicitly identify one or more suitable downlink (DL) communication beams to a network entity. In association with a random access channel (RACH) configuration process, the network entity indicates physical RACH (PRACH) preambles to the UE that include at least one PRACH preamble associated with two or more synchronization signal blocks (SSBs). The network entity periodically transmits SSBs on respective beams, having different respective directions or angular coverage. As the UE performs signal quality measurements of SSBs received on the respective beams, when multiple (e.g., two or more) SSBs exceed a quality threshold, which indicates the respective beams associated with the SSBs are suitable or adequate for communication, the UE selects one of the PRACH preambles associated with the multiple SSBs that exceed the threshold. The UE then transmits the selected PRACH preamble to the network entity. The UE may transmit the selected PRACH preamble in a RACH message, such as a message 1, in a 4-step RACH procedures, or a message A, in a 2-step RACH procedure.

The network entity will receive selected PRACH preambles from multiple served UEs. Some of the received selected PRACH preambles may indicate a single SSB associated with a single respective beam, while other selected PRACH preambles may indicate two or more SSBs associated with two or more respective beams. The network entity considers all of the beams identified by each of the received selected PRACH preambles to identify common beams between two or more UEs. For common transmissions to these two or more UEs, the network entity will use the common beam for the common transmissions.

In an example of two UEs, for which the network entity has a common transmission, if the first UE sends a PRACH preamble associated with a single, first SSB and the second UE sends a PRACH preamble associated with multiple SSBs, including the first SSB, the network entity may select the respective beam associated with the common first SSB to transmit the common transmission to the two UEs. Even if the second UE is not camped on the respective beam of the first SSB or may not have engaged in communications on that respective beam, because the second UE selected the PRACH preamble associated with the first SSB and one or more other SSBs, the network entity may still select the respective beam common to both UEs as indicated by each UE's selected PRACH preamble. After transmitting the PRACH preamble associated with the multiple SSBs, the second UE monitors all of the respective beams that are associated with each of the SSBs associated with the selected PRACH preamble for signaling from the network entity.

Particular implementations of the subject matter described in this disclosure can be implemented to realize one or more of the following potential advantages. By receiving a PRACH preamble from a UE, a network entity may more efficiently manage common transmissions to two or more UEs. Without an indication of such PRACH preamble associated with multiple SSBs, the network transmissions would send the common transmission on multiple, different beams, even though at least one UE may support communications on a common beam with one or more other UEs. The multiple transmissions of a common transmission increases overhead signaling and causes unnecessary transmissions. Accordingly, the present disclosure enables a reduction of overhead signaling and encourages the muting of unnecessary transmissions. Reduction of signaling and unnecessary transmission conserves both network and device resources, thereby potentially enabling energy savings by a network.

This disclosure further relates generally to providing or participating in authorized shared access between two or more wireless devices in one or more wireless communications systems, also referred to as wireless communications networks. In various implementations, the techniques and apparatus may be used for wireless communication networks such as CDMA networks, TDMA networks, FDMA networks, OFDMA networks, SC-FDMA networks, LTE networks, GSM networks, 5G or 5G NR networks, as well as other communications networks. As described herein, the terms “networks” and “systems” may be used interchangeably.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

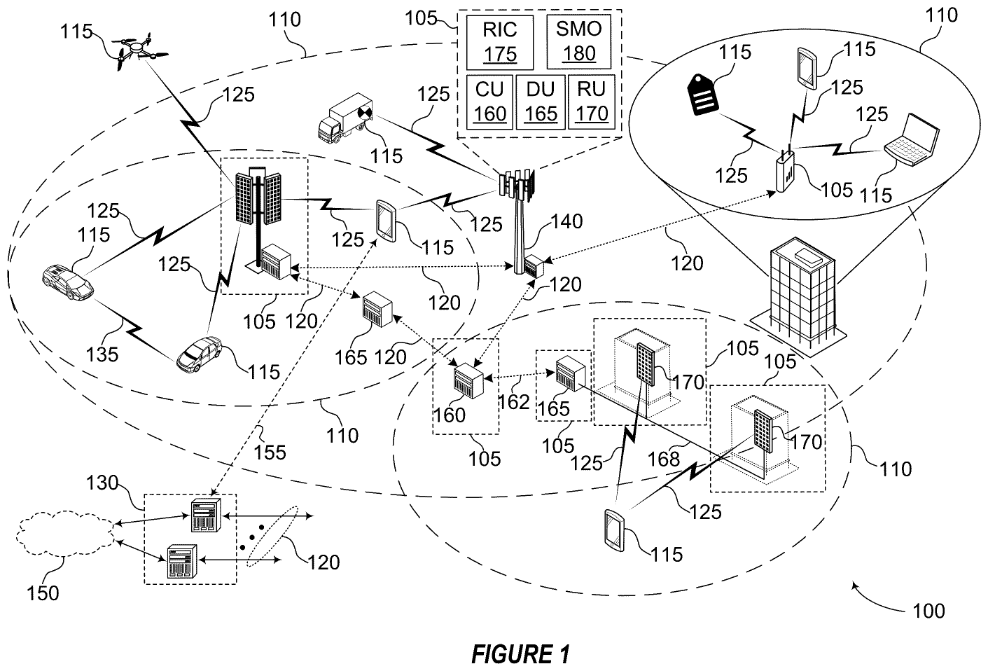

FIG. 1 illustrates an example of a wireless communications system 100 that supports beam-dependent scheduling offset determination in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a 5G NR network, or a network operating in accordance with other systems and radio technologies, including future systems and radio technologies, such as a 6G or ‘X’G networks, and others not explicitly mentioned herein.

The network entities 105 may be dispersed throughout a geographic area to form the wireless communications system 100 and may include devices in different forms or having different capabilities. In various examples, the network entity 105 may be referred to as a network element, a mobility element, a radio access network (RAN) node, or network equipment, among other nomenclature. In some examples, the network entities 105 and the UEs 115 may wirelessly communicate via one or more communication links 125 (e.g., a radio frequency (RF) access link).

The electromagnetic spectrum is often subdivided, based on frequency (or wavelength), into various classes, bands or channels. In fifth generation (5G) new radio (NR), two initial operating bands have been identified as frequency range designations FR1 (410 MHz-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band (or spectrum) in documents and articles, despite being different than the extremely high frequency (EHF) band (30 GHZ-300 GHz) which is identified by the International Telecommunications Union (ITU) as a mmWave band. With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

The UEs 115 may be dispersed throughout the coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be the network entity 105 (e.g., any network entity described herein), the UE 115 (e.g., any UE described herein), a network controller, an apparatus, a device, a computing system, one or more components, or another suitable processing entity configured to perform any of the techniques described herein. For example, a node may be the UE 115. As another example, a node may be the network entity 105.

In some examples, the network entities 105 may communicate with the core network 130, or with one another, or both. For example, the network entities 105 may communicate with the core network 130 via one or more backhaul communication links 120 (e.g., in accordance with an S1, N2, N3, or other interface protocol). In some examples, the network entities 105 may communicate with one another over the backhaul communication link 120 (e.g., in accordance with an X2, Xn, or other interface protocol) either directly (e.g., directly between the network entities 105) or indirectly (e.g., via the core network 130). In some examples, the network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, the midhaul communication links 162, or the fronthaul communication links 168 may be or include one or more wired links (e.g., an electrical link, an optical fiber link), one or more wireless links (e.g., a radio link, a wireless optical link), among other examples or various combinations thereof. The UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a transmission-reception point (TRP), a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, the network entity 105 (e.g., the base station 140) may be implemented in an aggregated (e.g., monolithic, standalone) base station architecture, which may be configured to utilize a protocol stack that is physically or logically integrated within a single network entity 105 (e.g., a single RAN node, such as the base station 140).

In some examples, the network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, the network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. The RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The UE 115 may include or may be referred to as a mobile device, a wireless device, a remote device, a handheld device, or a subscriber device, or some other suitable terminology, where the “device” may also be referred to as a unit, a station, a terminal, or a client, among other examples. The UE 115 may also include or may be referred to as a personal electronic device such as a cellular phone, a personal digital assistant (PDA), a tablet computer, a laptop computer, or a personal computer. In some examples, the UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, a satellite radio, a global positioning system (GPS) device, a global navigation satellite system (GNSS) device, a logistics controller, an unmanned aerial vehicle (UAV), a drone, a smart energy or security device, a solar panel or solar array, etc. among other examples.

When UE 115 refers to an IoT device, it may comprise a passive, semi-passive, or active IoT device, which may either have no on-device power or battery, or a power supply that operates the internal processing and control functionality, while using one or more forms of electromagnetic energy harvesting to power transmissions, such as through backscatter transmission. Such low or no-power IoT devices may also be referred to as ambient IoT devices. Such ambient IoT devices may receive RF signals from various forms of network entities, transmit-receive points (TRPs), or neighboring UE devices using sidelink communications. The ambient IoT device uses the electromagnetic energy in the RF signals to power transmissions. In some aspects, the ambient IoT device may store the received energy to immediately power its antenna array using a backscatter transmission or it may use the received energy to charge an onboard battery or other power source to use in transmissions.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125.

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific one of the UEs 115.

In some examples, the UE 115 may be able to communicate directly with other of the UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of the network entity 105 (e.g., the base station 140, the RU 170), which may support aspects of such D2D communications being configured by or scheduled by the network entity 105. In some examples, one or more UEs 115 in such a group may be outside of the coverage area 110 of the network entity 105 or may be otherwise unable to or not configured to receive transmissions from the network entity 105. In some examples, groups of the UEs 115 communicating via D2D communications may support a one-to-many (1:M) system in which each UE 115 transmits to each of the other ones of the UEs 115 in the group. In some examples, the network entity 105 may facilitate the scheduling of resources for D2D communications. In some other examples, D2D communications may be carried out between the UEs 115 without the involvement of the network entity 105.

In some systems, the D2D communication link 135 may be an example of a communication channel, such as a sidelink communication channel, between vehicles (e.g., the UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., the network entities 105, the base stations 140, the RUs 170) using vehicle-to-network (V2N) communications, or with both.

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between the UE 115 and the network entity 105 or the core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., the communication link 125, the D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

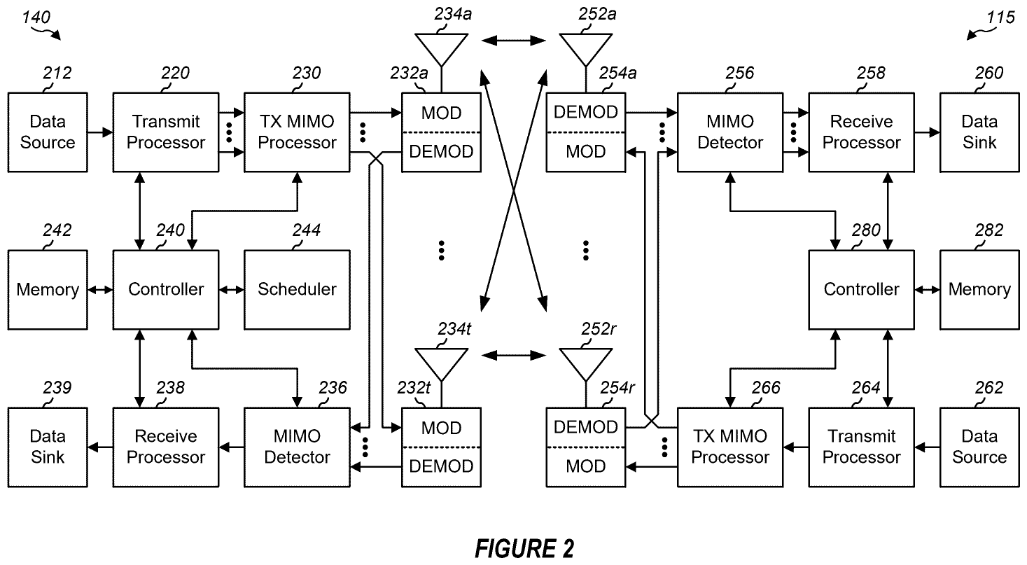

FIG. 2 is a block diagram illustrating examples of the base station 140 and the UE 115 according to one or more aspects. The base station 140 and the UE 115 may be any of the network entities and base stations and one of the UEs in FIG. 1. For a restricted association scenario (as mentioned above), the network entity 105 may be small cell base station, and the UE 115 may be the UE 115 operating in a service area of the small cell base station, which in order to access the small cell base station, would be included in a list of accessible UEs for the small cell base station. The base station 140 may also be a base station of some other type. As shown in FIG. 2, a network entity 105, such as the base station 140 may be equipped with the antennas 234a through 234t, and the UE 115 may be equipped with the antennas 252a through 252r for facilitating wireless communications.

At the base station 140, the transmit processor 220 may receive data from the data source 212 and control information from the controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, the transmit processor 220 may process (e.g., encode and symbol map) the data and control information to obtain data symbols and control symbols, respectively. The transmit processor 220 may also generate reference symbols, e.g., for the primary synchronization signal (PSS) and secondary synchronization signal (SSS), and cell-specific reference signal. The transmit (TX) MIMO processor 230 may perform spatial processing (e.g., precoding) on the data symbols, the control symbols, or the reference symbols, if applicable, and may provide output symbol streams to the modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from the modulators 232a through 232t may be transmitted via the antennas 234a through 234t, respectively.

At the UE 115, the antennas 252a through 252r may receive the downlink signals from the base station 140 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. The MIMO detector 256 may obtain received symbols from the demodulators 254a through 254r, perform MIMO detection on the received symbols if applicable, and provide detected symbols. The receive processor 258 may process (e.g., demodulate, deinterleave, and decode) the detected symbols, provide decoded data for the UE 115 to the data sink 260, and provide decoded control information to the controller 280, such as a processor.

On the uplink, at the UE 115, the transmit processor 264 may receive and process data (e.g., for a physical uplink shared channel (PUSCH)) from the data source 262 and control information (e.g., for a physical uplink control channel (PUCCH)) from the controller 280. Additionally, the transmit processor 264 may also generate reference symbols for a reference signal. The symbols from the transmit processor 264 may be precoded by the TX MIMO processor 266 if applicable, further processed by the modulators 254a through 254r (e.g., for SC-FDM, etc.), and transmitted to network entity 105. At the network entity 105, the uplink signals from the UE 115 may be received by the antennas 234, processed by the demodulators 232, detected by the MIMO detector 236 if applicable, and further processed by the receive processor 238 to obtain decoded data and control information sent by the UE 115. The receive processor 238 may provide the decoded data to the data sink 239 and the decoded control information to the controller 240.

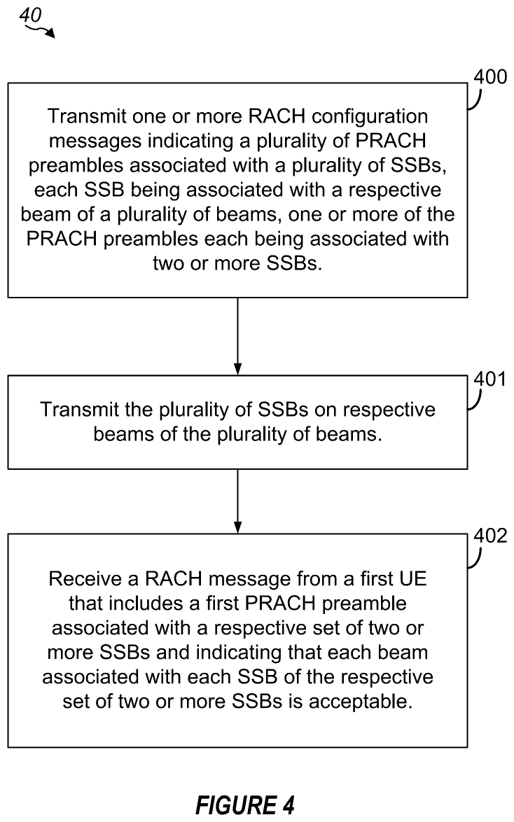

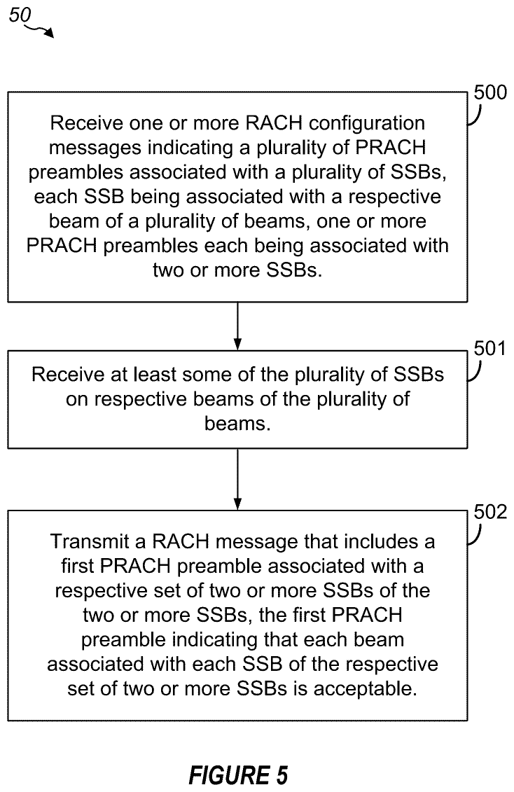

The controllers 240 and 280 may direct the operation at the base station 140 and the UE 115, respectively. The controller 240 or other processors and modules at the base station 140 or the controller 280 or other processors and modules at the UE 115 may perform or direct the execution of various processes for the techniques described herein, such as to perform or direct the execution illustrated in FIGS. 4 and 5, or other processes for the techniques described herein. The memories 242 and 282 may store data and program codes for the base station 140 and the UE 115, respectively. The scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

With the growing number of UEs connecting to wireless communication networks, network congestion increases not only due to the increased number of UEs communicating on the networks but because of the signaling overhead used to manage the communications with those UEs. Techniques to reduce signaling overhead and unnecessary transmissions may reduce network congestion and save energy at network devices. Various aspects of the present disclosure are directed to such energy savings and signaling overhead reduction by providing preamble-based identification of common beams.

Wireless communication networks typically have common communications for transmission to one or more neighboring UEs. Such common communications may include broadcast system information, such as master information blocks (MIBs), system information blocks (SIBs), and the like, or may also include multicast services that transmit the same information to multiple UEs enabled for the multicast service. Additionally, new communication techniques have been suggested to reduce unnecessary transmissions. For example, on-demand SIB Type-1(SIB1) functionality has been suggested to reduce transmissions by causing network entities to stop broadcasting SIB1 on all available beams. Instead, UEs in an idle or inactive mode may request SIB1 transmission, such as through an uplink wake-up signal configuration. When neighboring UEs request such on-demand SIB1 transmissions from the same network entity, the SIB1 would be common for each UE.

In order to efficiently manage transmission of the common communications, the network entity would transmit the communication using a beam commonly suitable for reception by two or more of the UEs. The different locations of the UEs could result in the UEs being on completely different beams, being on the same beam, or being on completely different beams even though one or more of the UEs could support transmissions on a common beam with one or more of the neighboring UEs. To reduce unnecessary transmissions, the network entity should transmit the common communication to UEs that share a common suitable beam on that common suitable beam. However, the network entity may not always know which beams are suitable for every UE, especially for UEs in an idle or inactive state.

A UE will generally determine suitable beams by performing quality measurements, such as reference signal receive power (RSRP) measurements, on SSBs received from the network entity. The respective beams associated with the received SSBs that meet a threshold quality measurement would be considered suitable by the UE. Instead of requiring the UEs to share such quality measurements for multiple SSBs with the network entity, various aspect of the present disclosure provide for this information to be implicitly indicated by the UE using a PRACH preamble associated with multiple SSBs.

For example, when the UE determines that multiple received SSBs meet a predetermined quality threshold, the UE would select a PRACH preamble associated with the multiple received SSBs that meet the threshold. The UE then transmits the selected PRACH preamble associated with the multiple SSBs to indicate multiple suitable beams to the network entity. The UE may report such a PRACH preamble in a RACH message (e.g., message 1 or message A) during a RACH occasion.

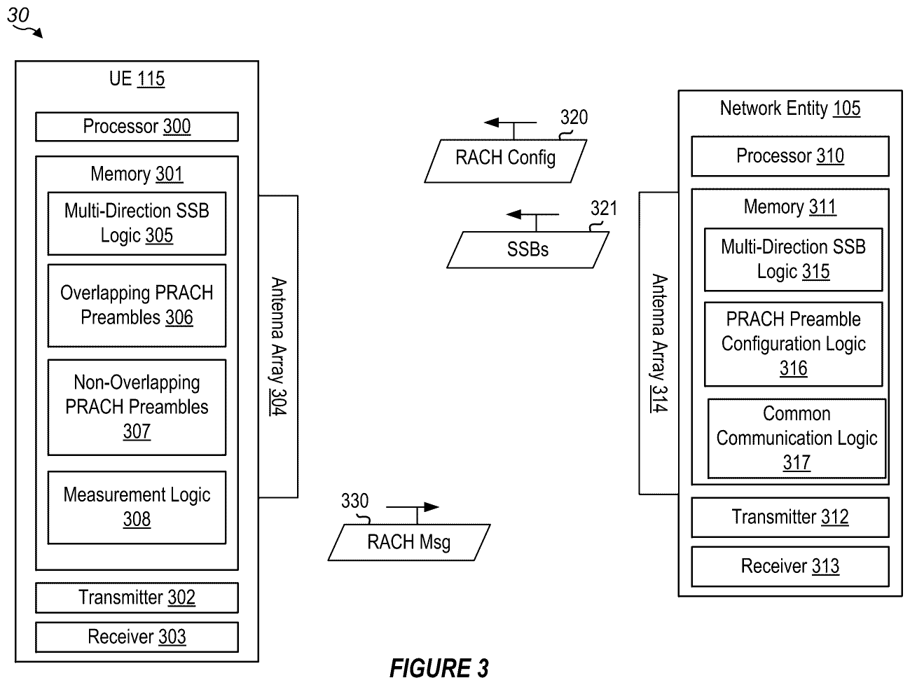

FIG. 3 is a block diagram of an example wireless communications system 30 that supports preamble-based indication of common beams according to one or more aspects. In some examples, the wireless communications system 30 may implement aspects of the wireless network 100. The wireless communications system 30 includes the UE 115 and the network entity 105. Although one UE 115 and one network entity 105 are illustrated, in some other implementations, the wireless communications system 30 may include multiple UEs 115, and may include more than one network entity 105.

The UE 115 includes a variety of components (such as structural, hardware components) used for carrying out one or more functions described herein. For example, these components can include one or more processors 300 (hereinafter referred to collectively as “the processor 300”), one or more memory devices 301 (hereinafter referred to collectively as “the memory 301”), one or more transmitters 302 (hereinafter referred to collectively as “the transmitter 302”), and one or more receivers 303 (hereinafter referred to collectively as “the receiver 303”) and one or more antenna arrays 304 (hereinafter referred to collectively as “the antenna array 304”). The processor 300 may be configured to execute instructions stored in the memory 301 to perform the operations described herein. In some implementations, the processor 300 includes or corresponds to one or more of the receive processor 258 (FIG. 2), the transmit processor 264 (FIG. 2), and the controller 280 (FIG. 2), and the memory 304 includes or corresponds to the memory 282 (FIG. 2).

The memory 301 includes or is configured to store multi-direction SSB logic 305, overlapping PRACH preambles 306, non-overlapping PRACH preambles 307, and measurement logic 308, among other information and logic. As used herein, “overlapping,” such as in overlapping PRACH preambles 306, refers to the PRACH preambles associated with two or more SSBs, while “non-overlapping,” such as in non-overlapping PRACH preambles 307, refers to the PRACH preambles associated with a single SSB.

The transmitter 302 is configured to transmit reference signals, control information, and data to one or more other devices, and the receiver 303 is configured to receive references signals, synchronization signals, control information, and data from one or more other devices. For example, the transmitter 302 may transmit signaling, control information, and data to, and the receiver 303 may receive signaling, control information, and data from, the network entity 105. In some implementations, the transmitter 302 and the receiver 303 may be integrated in one or more transceivers. Additionally or alternatively, the transmitter 302 or the receiver 303 may include or correspond to one or more components of the UE 115 described with reference to FIG. 2.

The antenna array 304 may include multiple antenna elements configured to perform wireless communications with other devices, such as with the network entity 105. In some implementations, the antenna array 304 may be configured to perform wireless communications using different beams, also referred to as antenna beams. The beams may include TX beams and RX beams. To illustrate, the antenna array 304 may include multiple independent sets (or subsets) of antenna elements (or multiple individual antenna arrays), and each set of antenna elements of the antenna array 304 may be configured to communicate using a different respective beam that may have a different respective direction than the other beams. For example, a first set of antenna elements of the antenna array 304 may be configured to communicate via a first beam having a first direction, and a second set of antenna elements of the antenna array 304 may be configured to communicate via a second beam having a second direction. In other implementations, the antenna array 304 may be configured to communicate via more than two beams. Alternatively, one or more sets of antenna elements of the antenna array 304 may be configured to concurrently generate multiple beams, for example using multiple RF chains of the UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array 304 may include or correspond to multiple antenna panels, and each antenna panel may be configured to communicate using a different respective beam.

The network entity 105 can include a variety of components (such as structural, hardware components) used for carrying out one or more functions described herein. For example, these components can include one or more processors 310 (hereinafter referred to collectively as “the processor 310”), one or more memory devices 311 (hereinafter referred to collectively as “the memory 311”), one or more transmitters 312 (hereinafter referred to collectively as “the transmitter 312”), and one or more receivers 358 (hereinafter referred to collectively as “the receiver 313”) and one or more antenna arrays 314 (hereinafter referred to collectively as “the antenna array 314”). The processor 310 may be configured to execute instructions stored in the memory 311 to perform the operations described herein. In some implementations, the processor 310 includes or corresponds to component of base station 140 illustrated in FIG. 2, such as one or more of the receive processor 238, the transmit processor 220, and the controller 240, and the memory 311 includes or corresponds to the memory 242.

The memory 311 includes or is configured to store multi-direction SSB logic 315, PRACH preamble configuration logic 316, and common communication logic 317, among other information and logic.

The transmitter 312 is configured to transmit reference signals, synchronization signals, control information and data to one or more other devices, and the receiver 313 is configured to receive reference signals, control information, and data from one or more other devices. For example, the transmitter 312 may transmit signaling, control information, and data to, and the receiver 313 may receive signaling, control information and data from, the UE 115. In some implementations, the transmitter 312 and the receiver 313 may be integrated in one or more transceivers. Additionally or alternatively, the transmitter 312 or the receiver 313 may include or correspond to one or more components of base station 140 described with reference to FIG. 2.

The antenna array 314 may include multiple antenna elements configured to perform wireless communications with other devices, such as with the UE 115. In some implementations, the antenna array 314 may be configured to perform wireless communications using different beams, also referred to as antenna beams. The beams may include TX beams and RX beams. To illustrate, the antenna array 314 may include multiple independent sets (or subsets) of antenna elements (or multiple individual antenna arrays), and each set of antenna elements of the antenna array 314 may be configured to communicate using a different respective beam that may have a different respective direction than the other beams. For example, a first set of antenna elements of the antenna array 314 may be configured to communicate via a first beam having a first direction, and a second set of antenna elements of the antenna array 314 may be configured to communicate via a second beam having a second direction. In other implementations, the antenna array 314 may be configured to communicate via more than two beams. Alternatively, one or more sets of antenna elements of the antenna array 314 may be configured to concurrently generate multiple beams, for example using multiple RF chains of the network entity 105. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array 314 may include or correspond to multiple antenna panels, and each antenna panel may be configured to communicate using a different respective beam.

In some implementations, the wireless communications system 30 implements a 5G NR network. For example, the wireless communications system 30 may include multiple 5G-capable UEs 115 and multiple 5G-capable network entities 105, such as UEs and base stations configured to operate in accordance with a 5G NR network protocol such as that defined by the 3GPP.

During operation of the wireless communications system 30, the network entity 105 executes the multi-direction SSB logic 315 and the PRACH preamble configuration logic 316 under control of the processor 310. Within the execution environment of the multi-direction SSB logic 315 and the PRACH preamble configuration logic 316, the network entity 105 enables the functionality for UEs to indicate multiple suitable beams for downlink transmission using a single PRACH preamble. The network entity 105 configures a number of PRACH preambles in which at least one of these PRACH preambles associates with two or more SSBs. The network entity 105 transmits RACH configuration messages 320, via the transmitter 312 and antenna array 314, that indicates at least the PRACH preambles associated with two or more SSBs or that additionally indicates other PRACH preambles associated with a single SSB.

The UE 115 receives the RACH configuration messages 320 via the antenna array 304 and the receiver 303. The UE 115, under control of processor 300, executes the multi-direction SSB logic 305. The execution environment of the multi-direction SSB logic 305 enables the functionality of the UE 115 to identify the PRACH preambles associated with two or more SSBs indicated in the RACH configuration messages 320. The UE 115 stores the indicated PRACH preambles associated with two or more SSBs in memory 301 at the overlapping PRACH preambles 306, and the PRACH preambles associated with a single SSB in memory 301 at the non-overlapping PRACH preambles 306.

Periodically, the network entity 105 transmits SSBs 321 on multiple respective beams via the transmitter 312 and antenna array 314. The UE 115 receives at least some of the SSBs 321. Within the execution environment of the multi-direction SSB logic 305, the UE 115 executes, under control of the processor 300, the measurement logic 308. The execution environment of the measurement logic 308 enables measurement functionality at the UE 115, including measurement functionality for measuring signals, such as RSRP, SNR, and the like, as well as internal measurement functionality, such as comparing signal measurements against predetermined thresholds, system requirements, and the like. The UE 115, within the execution environment of measurement logic 308, measures the signal quality of the SSBs received via the antenna array 304 and the receiver 303 and compares the signal quality measurement of each received SSB against a signal quality threshold. The UE 115 may then identify one or more suitable beams that are associated with one or more SSBs, for which the signal quality measurement of the one or more SSBs has met the threshold level.

Within the execution environment of multi-direction SSB logic 305, the UE 115 selects a PRACH preamble from the preambles stored at overlapping PRACH preambles 306 or the non-overlapping PRACH preambles 307 according to whether the UE 115 identified a single suitable beam or multiple suitable beams. When the UE 115 identifies a single suitable beam, it selects a PRACH preamble from the non-overlapping PRACH preambles 307 associated with the SSB received on the single suitable beam, and when the UE 115 identifies multiple suitable beams, it selects an PRACH preamble from the overlapping PRACH preambles 306 associated with each of the multiple SSBs received on the multiple suitable beams. The UE 115 may then transmit RACH message 330, via the transmitter 302 and antenna array 304, that includes the selected PRACH preamble.

Within the execution environment of multi-direction SSB logic 315, the network entity 105 receives the RACH message 330 containing the selected PRACH preamble via antenna array 314 and receiver 313. The network entity 105 executes, under control of the processor 310, the common communication logic 317. The execution environment of the common communication logic 317 provides the features and functionality to the network entity 105 to identify common beams indicated in the reported PRACH preambles from the UE 115 and other neighboring UEs. The network entity 105 may then select a common beam for transmitting common communications to the reporting UEs, including UE 115. Thus, the network entity 105 could send a single instance of the common communication on a common beam that was identified as suitable by multiple UEs even if any of those UEs is not currently camped on that beam or had not previously been associated with that beam.

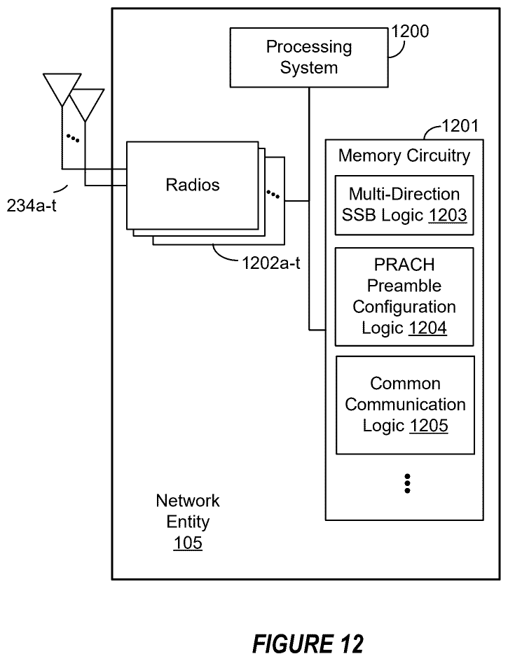

FIG. 4 is a flow diagram illustrating an example process 40 that supports preamble-based identification of common beams according to one or more aspects. Operations of the process 40 may be performed by a network entity, such as the network entity 105 or base station 140 described above with reference to FIGS. 1-3 or a network entity 105 as described with reference to FIG. 12. For example, example operations of the process 40 may enable the network entity 105 to indicate to served UEs PRACH preamble groupings that include at least one PRACH preamble grouping having one or more overlapping PRACH preambles associated with two or more SSBs and then determine a common beam for transmitting common communications to two or more UEs based on common SSBs associated with the PRACH preambles received in RACH messages received from the two or more UEs.

In block 400, the network entity 105 transmits one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs. For example, the network entity 105 may configure multiple PRACH preambles, at least one of which associates with two or more SSBs. The network entity 105 transmits one or more RACH configuration messages to UEs that indicate the PRACH preambles associated with the SSBs, including the one or more RACH preambles associated with two or more SSBs.

In block 401, the network entity 105 transmits the plurality of SSBs on respective beams of the plurality of beams. For example, the network entity 105 may periodically transmit multiple SSBs on multiple associated beams. The beams, on which the network entity 105 transmits the SSBs, may have different respective directions or angular coverage emanating from the network entity 105.

In block 402, the network entity 105 receives a RACH message from a first UE that includes a first PRACH preamble from the one or more PRACH preambles, the first PRACH preamble associated with a respective set of two or more SSBs of the two or more SSBs and indicating that each beam associated with each SSB of the respective set of two or more SSBs is acceptable. For example, the network entity 105 may receive a RACH message, such as a message 1 in a 4-step RACH process or a message A in a 2-step RACH process, from multiple UEs that includes a PRACH preamble selected by the reporting UE associated with either a single SSB or multiple SSBs. The network entity 105 may determine that the respective beam or beams associated with either the single SSB or the multiple SSBs identified by the PRACH preamble are suitable for communication by the reporting UE.

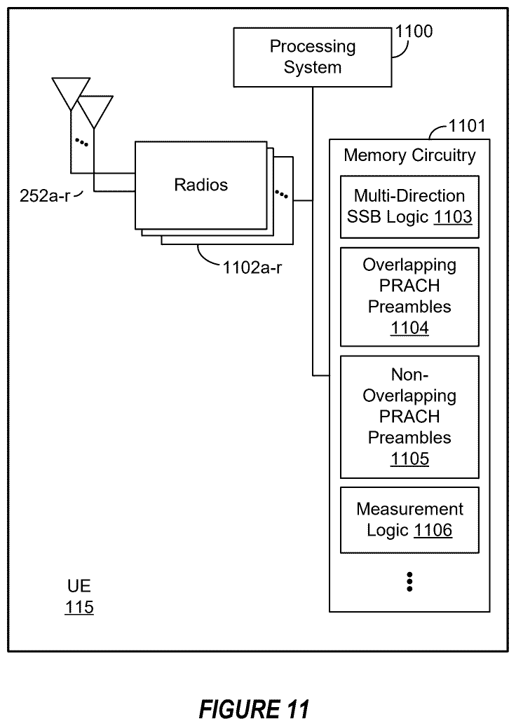

FIG. 5 is a flow diagram illustrating an example process 50 that supports preamble-based identification of common beams according to one or more aspects. Operations of the process 50 may be performed by a UE, such as the UE 115 described above with reference to FIGS. 1-3 or a UE 115 as described with reference to FIG. 11. For example, example operations (also referred to as “blocks”) of the process 50 may enable the UE 115 to identify and provide PRACH preamble reporting that indicates to a network entity that the UE 115 has determined multiple beams as suitable for communications.

In block 500, the UE 115 receives one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs. For example, the UE 115 receives RACH configuration messages from a network entity that indicates PRACH preambles, including at least one PRACH preamble associated with two or more SSBs.

In block 501, the UE 115 receives at least some of the plurality of SSBs on respective beams of the plurality of beams. For example, the UE 115 may detect and receive SSBs on respective beams. Depending on the location of the UE 115 relative to the network entity, the UE 115 may not detect and receive all of the SSBs transmitted by the network entity.

In block 502, the UE 115 transmits a RACH message that includes a first PRACH preamble from the first set of one or more PRACH preambles associated with a respective set of two or more SSBs of the two or more SSBs, the first PRACH preamble indicating that each beam associated with each SSB of the respective set of two or more SSBs is acceptable. For example, the UE 115 measures a signal quality, such as an RSRP measurement, of each of the SSBs that it detects and receives on the respective beams. The UE 115 compares the signal quality measurements against a predetermined quality threshold. Such threshold may comprise a cell access RSRP threshold or may comprise a special signal quality threshold specifically for the UE 115 to determine a suitability of multiple beams. The UE 115 may then select a PRACH preamble associated with the one or more SSBs having a signal quality that meets the quality threshold. The respective beams of those one or more SSBs that meet the quality threshold are considered acceptable or suitable for communication by the UE 115. The UE 115 then transmits the selected PRACH preamble to the network entity in a RACH message.

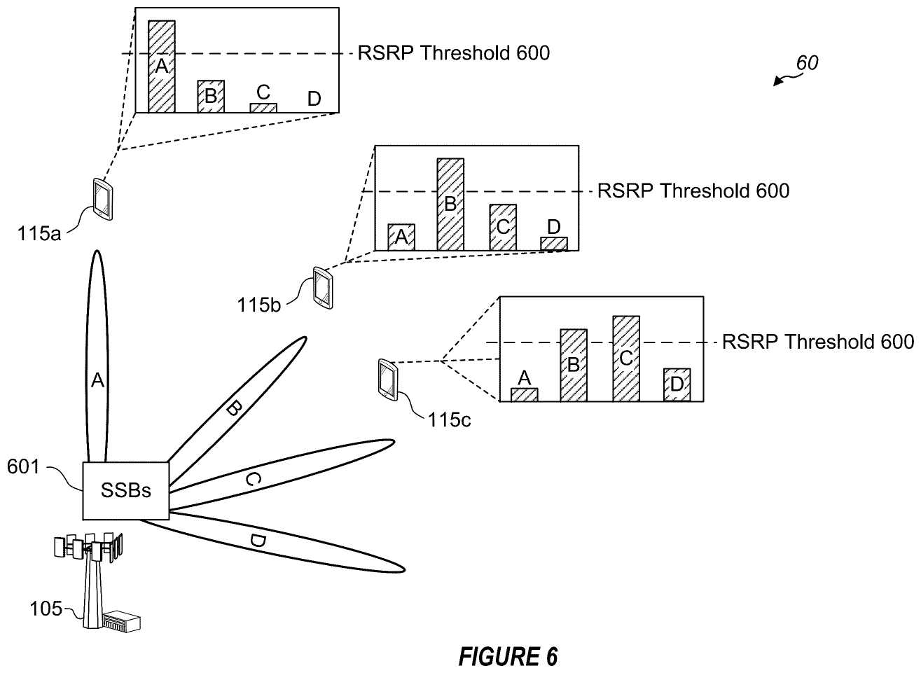

FIG. 6 is a block diagram illustrating a wireless network 60 including a network entity 105 and UEs 115a-115c, each of which supports preamble-based identification of common beams according to one or more aspects. The network entity 105 provides wireless communication services for the wireless network 60 including common communications transmitted for use by multiple UEs. The UEs 115a-115c may be in an idle or inactive state or may be in an active state within the wireless network 60. The network entity 105 periodically transmits SSBs 601 on multiple directional beams, such as beams A-D, that allow UEs, such as the UEs 115a-115c, to establishing synchronization and measure channel quality for the different received beams.

As a part of the system information received by the UEs 115a-115c to perform random access procedures or when first accessing the wireless network 60 served by the network entity 105, the UEs 115a-115c may receive configuration information including an RSRP threshold 600. The RSRP threshold 600 may comprise a cell RSRP threshold that defines a minimum receive power level that a UE should observe on signals carried on a particular beam or other communication channel in order to perform initial access to the wireless network 60. According to aspects of the present disclosure, the RSRP threshold 600 may alternatively comprise a directional RSRP threshold that defines the threshold measurement that a UE should observe on signals carried on respective beams to determine which, if any, one or more beams or communication channels out of multiple, observable beams or communication channels would support suitable communications by the UE.

The UEs 115a-115c may camp on or connect to (collectively referred to herein as “associate with”) a certain directional beam, respective of its connected state. For example, the UE 115a associates with beam A, the UE 115b associates with beam B, and the UE 115c associates with beam C. While associated with certain beams, the UEs 115a-115c also perform signal quality measurements, such as RSRP measurements, of at least some of SSBs 601 that it detects on the respective beams. Based on the location of the UEs 115a-115c with respect to the network entity 105, each of the UEs 115a-115c may determine one or more suitable beams by comparing the RSRP measurements against the RSRP threshold 600.

As illustrated in the example aspect, the UE 115a determines that the RSRP measurement of the SSB of the SSBs 601 for beam A meets the RSRP threshold 600, while the RSRP measurements of the SSBs of the SSBs 601 for beams B and C do not, and UE 115a fails to detect any signals on beam D; the UE 115b determines that the RSRP measurement of the SSB of the SSBs 601 for beam B meets the RSRP threshold 600, while the RSRP measurements of the SSBs of the SSBs 601 for beams A, C, and D do not; and the UE 115c determines that the RSRP measurement of the SSBs of the SSBs 601 for beams B and C meet the RSRP threshold 600, while the RSRP measurements of the SSBs of the SSBs 601 for beams A and D do not. Thus, the UEs 115a and 115b identify their respective associated beams as suitable for communications, while the UE 115c identifies both its associated beam C and a beam with which it is not associated, beam B, as suitable for communications.

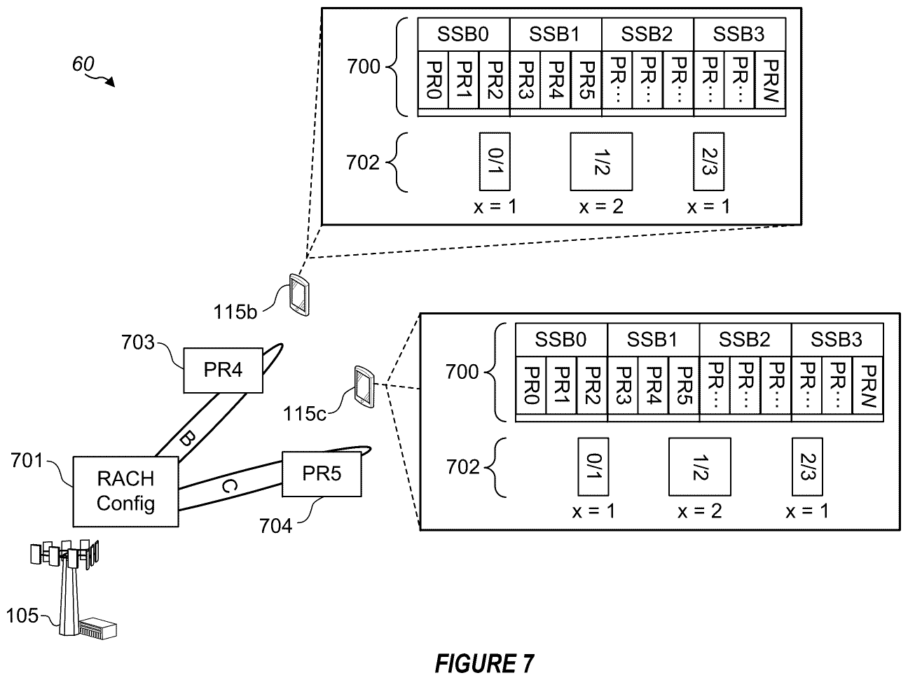

FIG. 7 is a block diagram illustrating the wireless network 60 including the network entity 105 and the UEs 115b and 115c, each of which supports preamble-based identification of common beams according to one or more aspects. FIG. 7 illustrates certain different aspects or operations of the wireless network 60 than FIG. 6, but also maintains the aspects or operations illustrated in FIG. 6. For example, FIG. 7 illustrates beams B and C and the UEs 115b and 115c, even though beams A and D, as well as the UE 115a are present in the wireless network 60, as illustrated in FIG. 6. The network entity 105 transmits the RACH configuration messages 701 on multiple beam directions, such as beams B and C. As the RACH configuration process includes multiple messages transmitted by the network entity 105 at various different times, the RACH configuration messages 701 represents these multiple messages.

As a part of the RACH configuration process, the network entity 105 sends a listing of available PRACH preambles 700 in the RACH configuration messages 701 that identifies available PRACH preambles, such as PRACH preambles PR0-PRN, grouped according to the SSB index that the PRACH preambles associate with, such as SSB indices SSB0-SSB3 . The UEs 115b and 115c store the listing of available PRACH preambles 700 on receipt as a part of its RACH configuration. Under existing operations and capabilities, each PRACH preamble of the listing of available PRACH preambles maps to a single SSB index in a sequential manner, such that each PRACH preamble within a group of PRACH preambles maps to the same, individual SSB index.

In accordance with aspects of the present disclosure, the network entity 105 sends an additional configuration message in the RACH configuration messages 701 indicating at least one PRACH preamble that associates with two or more SSBs. In the example implementation of the illustrated aspect, the RACH configuration messages 701 include an assigned number value, x 702, of PRACH preambles within a group of PRACH preambles that associates with the same set or combination of two or more SSBs. As illustrated, the assigned number value, x 702, of PRACH preambles that associate with the same set or combination of two or more SSBs is different for each set or combination of SSBs. For example, the assigned number value, x 702, includes x=1 for the sets or combinations of SSB0/SSB1 (0/1) and SSB2/SSB3 (2/3), and x=2 for the set or combination of SSB1/SSB2 (1/2). Therefore, the set or combination of SSB0/SSB1 includes one PRACH preamble associated with both SSB0 and SSB1, the set or combination of SSB1/SSB2 includes two PRACH preambles associated with both SSB1 and SSB2, and the set or combination of SSB2/SSB3 includes one PRACH preamble associated with both SSB2 and SSB3.

As noted in the example aspect, a group of PRACH preambles that associates with the same set or combination of two or more SSBs can consist of a single preamble or can include multiple preambles. Additionally, while the example aspect illustrates the assigned number value, x 702, identifying a different number for each group of PRACH preambles that associates with the same set or combination of two or more SSBs, alternative aspects may provide for the same value of x 702 for all such groups of PRACH preambles.

Referring back to FIG. 6, the UEs 115b and 115c measured and compared the signal quality of the different, detected SSBs of SSBs 601 to identify suitable beams from the different respective beams on which the UEs 115b and 115c received the SSBs. The UE 115b identified beam B, on which it received SSB1, as suitable, while the UE 115b identified beams B and C, on which it received SSB1 and SSB2, respectively. According to the various aspects described herein, the UEs 115b and 115c, in FIG. 7, select a PRACH preamble according to their respective measurements of received SSBs meeting the predetermined quality threshold, RSRP threshold 600. The UE 115b identified a single beam, beam B, as suitable for communication, thus, the UE 115b selects a PRACH preamble associated singly with SSB1, for example, PR4. The UE 115c identified two beams, beams B and C, as suitable for communication, thus, the UE 115c selects a PRACH preamble associated with both SSB1 and SSB2, for example, PR5. The UE 115b sends the selected PRACH preamble, PR4, in a RACH message 703 on its associated beam, beam B, to the network entity 105, while the UE 115c sends the selected PRACH preamble, PR5, in a RACH message 704 on its associated beam, beam C, to the network entity 105.

On receipt of RACH messages 703 and 704, the network entity 105 may select an appropriate beam or beams on which to send any common communication to the UEs 115b and 115c. While the UEs 115b and 115c are associated with different beams, beams B and C, respectively, the UE 115c's selected PRACH preamble, PR5, indicates to the network entity 105 that the UE 115c may receive communications on either beam B or beam C. However, because the UE 115b's selected PRACH preamble, PR5, indicates a single suitable beam, beam B, the network entity 105 would select the common beam, beam B, on which to transmit a common communication. On the UE side, because the UE 115c selected a PRACH preamble associated with two or more SSBs, while the UE 115c associates with beam C, it will monitor both beams B and C for signaling or communications from the network entity 105.

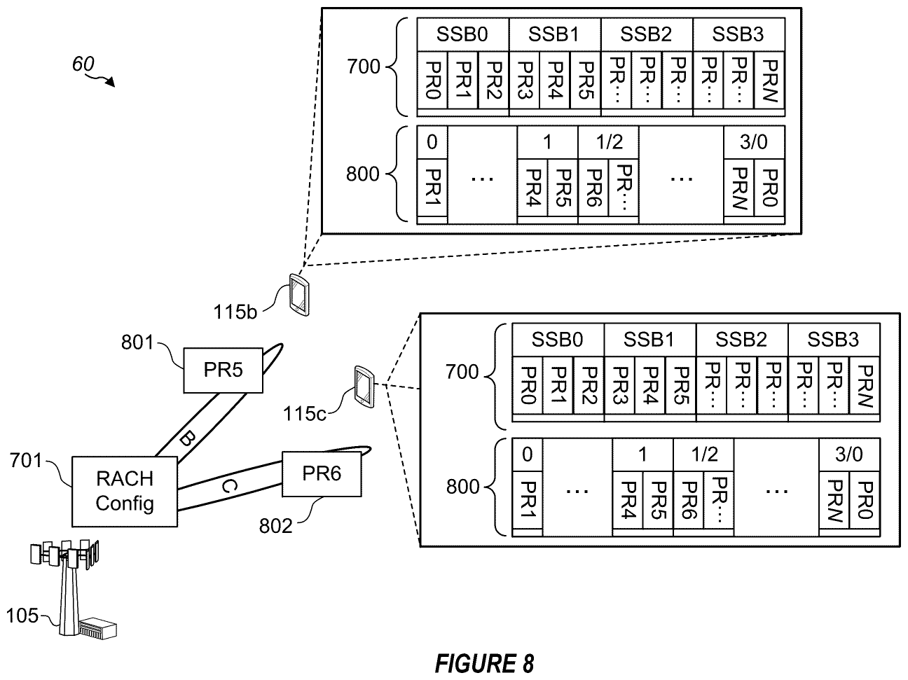

FIG. 8 is a block diagram illustrating the wireless network 60 including the network entity 105 and the UEs 115b and 115c, each of which supports preamble-based identification of common beams according to one or more aspects. FIG. 8 illustrates certain different aspects or operations of the wireless network 60 than FIG. 6, but also maintains the aspects or operations illustrated in FIG. 6. FIG. 8 also illustrates alternative aspects or operations of the wireless network 60 to FIG. 7, but also maintains certain aspects or operations of FIG. 7, such as the transmission of RACH configuration messages 701 by the network entity 105.

The UEs 115b and 115c have stored the listing of available PRACH preambles 700, as received in FIG. 7 in the RACH configuration messages 701. In accordance with alternative aspects of the present disclosure, the network entity 105, in FIG. 8, sends an additional configuration message in the RACH configuration messages 701 including configured PRACH preambles 800 that reflect groups of PRACH preambles associated with a single SSB and groups of PRACH preambles associated with two or more SSBs. The configured PRACH preambles 800 may further define groups of PRACH preambles with non-consecutive PRACH preambles associated with the same set or combination of SSBs. For example, the set or combination of SSB3/SSB0 includes the non-consecutive PRACH preambles, PRN and PR0. The UEs 115b and 115c may then use the configured PRACH preambles 800 to select a PRACH preamble based on their respective measurements of received SSBs meeting the predefined quality threshold.

The UE 115b identified a single beam, beam B, as suitable for communication, thus, the UE 115b selects a PRACH preamble associated singly with SSB1 from the defined preamble groupings 800 associated with a single SSB, for example, PR5. The UE 115c identified two beams, beams B and C, as suitable for communication, thus, the UE 115c selects a PRACH preamble associated with both SSB1 and SSB2 from the configured PRACH preambles 800 associated with the set or combination of SSB1/SSB2, for example, PR6. The UE 115b sends the selected PRACH preamble, PR5, in a RACH message 801 on its associated beam, beam B, to the network entity 105, and the UE 115c sends the selected PRACH preamble, PR6, in a RACH message 802 on its associated beam, beam C, to the network entity 105. Similar to the procedure described with respect to FIG. 7, on receipt of the RACH messages 801 and 802, the network entity 105 may select the common beam, beam B, on which to transmit a common communication to the UEs 115b and 115c.

It should be noted that, in alternative aspects of the present disclosure, the configured PRACH preambles 800 may be defined by the network entity using a predefined number value for PRACH preambles within a group of PRACH preambles that associates with the same set or combination of two or more SSBs, similar to the assigned number value, x 702 (FIG. 7). For example, using the predefined number value, x, the network entity 105 may define the groups of PRACH preambles according to: Group A (0 to N−1) PRACH preambles associated with a single SSB, Group A and B (N to N+x−1) PRACH preambles associated with two SSBs, and Group B (N+x to 2N+x−1) PRACH preambles associated with a single SSB.

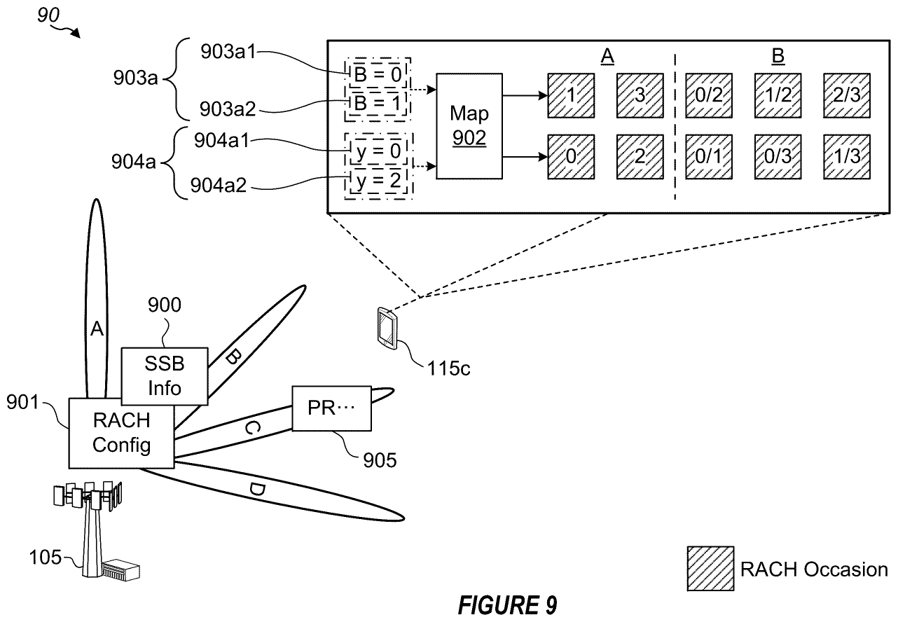

FIG. 9 is a block diagram illustrating the wireless network 90 including a network entity 105 and a UE 115c, each of which supports preamble-based identification of common beams according to one or more aspects. Similar to the wireless network 60 of FIG. 6, the network entity 105 provides wireless communication services for the wireless network 90 including common communications transmitted for use by multiple UEs. The UE 115c may be in an idle or inactive state within the wireless network 90. The network entity 105 periodically transmits SSBs, such as SSBs 601 (FIG. 6), on multiple directional beams, such as beams A-D, that allow UEs, such as the UE 115c, to establishing synchronization and measure channel quality for the different received beams.

In accordance with various aspects of the present disclosure, the UE 115c may use RACH occasions to implement the capability of identifying multiple suitable beams for communications. The network entity 105 sends an identification in SSB information 900 of the SSBs that it will transmit. The network entity 105 may further send RACH configuration messages 901 including information and parameters for UEs, such as the UE 115c, to configure RACH communications. Similar to the description of RACH configuration messages 701 of FIG. 7, RACH configuration messages 901 represent the multiple messages transmitted by the network entity 105 at various different times as a part of the RACH configuration process. Existing parameters for RACH configuration include the number of RACH opportunities per SSB and the number of PRACH preambles per RACH occasion (for example, via the parameter ssb-perRACH-OccasionAndCB-PreamblesPerSSB). According to the described aspect, the RACH configuration messages 901 include identification of the available RACH opportunities and further identifies an indicator that indicates whether the capability of the UE 115c to indicate more than one suitable beam using a single PRACH preamble is enabled or disabled.

On the UE side, the UE 115c stores the identification of SSBs to be transmitted by the network entity 105, received in the SSB information 900, and stores the available RACH occasions and indicator, received in the RACH configuration messages 901. With the receipt of the indicator enabling the capability to indicate more than one suitable beam using a single PRACH preamble, the UE 115c performs map process 902 to map SSB indices to the available RACH occasions. According to the illustrated example, the SSB information 900 identifies that the network entity 105 will transmit SSBs associated with indices SSB0-SSB3. The UE 115c begins mapping the individual SSB indices to the available RACH occasions in a one-to-one fashion. As illustrated in section A of the RACH occasions stored at the UE 115c, the UE 115c maps a single SSB index to a single RACH occasions. Once the UE 115c maps all of the single SSB indices associated with the SSBs to be transmitted to a single RACH occasion, it then begins mapping combinations of SSB indices, according to the number SSB combinations supported per RACH occasion. As illustrated in section B of the RACH occasions stored at the UE 115c, the UE 115c maps two SSB indices to each remaining RACH occasion until all RACH occasions have been mapped to or all combinations of SSB indices have been mapped.

For purposes of the illustrated aspect, the UE 115c has identified two suitable beams, beams B and C, based on RSRP measurements, as discussed with respect to FIG. 6. Once the UE 115c maps all SSB indices and combinations of SSB indices to the available RACH occasions through map process 902, it may select a PRACH preamble to transmit in the RACH message 905 to the network entity 105. The UE 115c selects the PRACH preamble associated with the RACH occasion that has been mapped with the combination of SSB indices associated with beams B and C. As described with respect to FIGS. 7 and 8, the network entity 105 uses the PRACH preamble received from the UE 115c to determine common beams to use to transmit common communications to the UE 115c and any other neighboring UEs, regardless of the beam currently associated with the UE 115c. Additionally, because it reports an overlapping preamble, the UE 115c would monitor each beam, beams B and C, associated with the selected PRACH preamble for communications from the network entity 105.

The indicator received by the UE 115c in the RACH configuration messages 901 that enables or disables the capability to indicate more than one suitable beam using a single PRACH preamble may comprise a binary or Boolean indicator that either enables or disables the capability or may comprise an integer indicator that either identifies the number value of combined SSBs supported per RACH occasion or disables the capability, such as when the value of the integer indicator=0.

In a first alternative implementation of the aspect illustrated in FIG. 9, the indicator 903a comprises a Boolean or binary indicator. When the network entity 105 sets the indicator 903a1 to 0 (B=0), the UE 115c, upon receipt of the enablement indicator 903a1 in the RACH configuration messages 901, disables the capability to indicate more than one suitable beam using a single PRACH preamble. In such case, the UE 103c will perform map process 902 to map single SSB indices to single RACH occasions, such as illustrated in section A of the RACH occasions stored at the UE 115c. The UE 103c will repeat mapping each single SSB index to a single RACH occasion until all available RACH occasions have been mapped to. When the network entity 105 sets the indicator 903a2 to 1 (B=1), the UE 115c enables the capability to indicate more than one suitable beam using a single PRACH preamble and performs map process 902, as described above, mapping the single SSB indices to single RACH occasions, as in section A, and mapping the combinations of SSB indices to single RACH occasions, as in section B.

In a second alternative implementation of the aspect illustrated in FIG. 9, the indicator 904a comprises an integer indicator. When the network entity 105 sets the value of the indicator 904a1 to 0 (y=0), the UE 115c, upon receipt of the indicator 904a1 in the RACH configuration messages 901, disables the capability to indicate more than one suitable beam using a single PRACH preamble. In such case, the UE 103c will perform map process 902 to map single SSB indices to single RACH occasions, such as illustrated in section A of the RACH occasions stored at the UE 115c. The UE 103c will repeat mapping each single SSB index to a single RACH occasion until all available RACH occasions have been mapped to. When the network entity 105 sets the value of the indicator 904a2 to a positive integer value, illustrated in the present example aspect as 2 (y=2), the UE 115c enables the capability to indicate more than one suitable beam using a single PRACH preamble and performs map process 902 as described above, mapping the single SSB indices to single RACH occasions, as in section A, and mapping combinations of two or more SSB indices to single RACH occasions, as in section B.

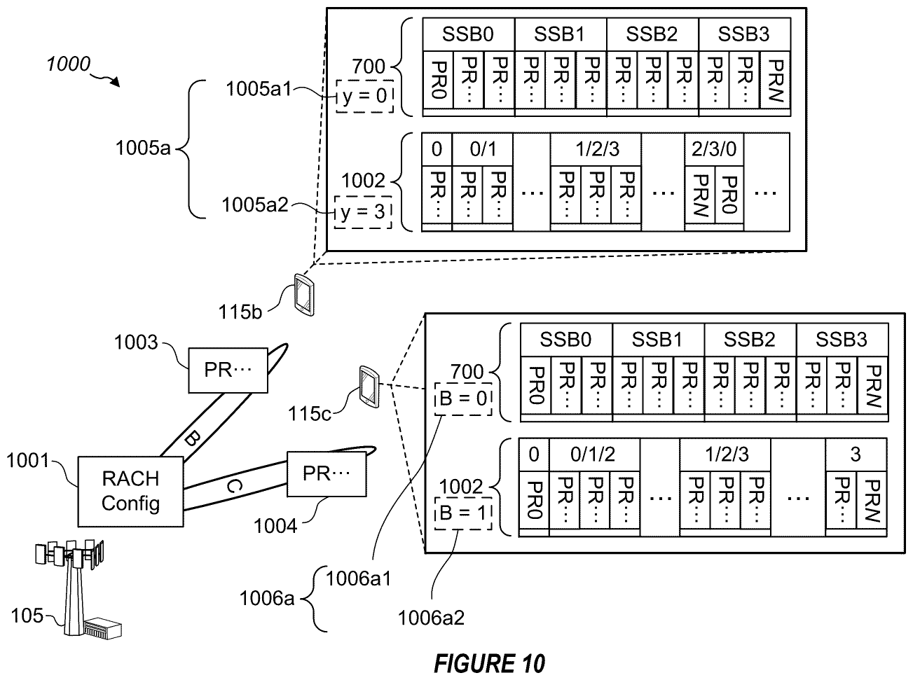

FIG. 10 is a block diagram illustrating the wireless network 1000 including a network entity 105 and UEs 115b and 115c, each of which supports preamble-based identification of common beams according to one or more aspects. Similar to the wireless network 60 of FIGS. 6 and 7, the network entity 105 provides wireless communication services for the wireless network 1000 including common communications transmitted for use by multiple UEs. The UEs 115b and 115c may be in an idle or inactive state within the wireless network 1000. The network entity 105 periodically transmits SSBs, such as SSBs 601 (FIG. 6), on multiple directional beams, such as beams B and C, that allow UEs, such as the UEs 115b and 115c, to establishing synchronization and measure channel quality for the different received beams. The network entity 105 may also transmit the RACH configuration messages 1001, similar to the RACH configuration messages 701 (FIG. 7), which may include a listing of available PRACH preambles 700 that identifies available PRACH preambles, such as PRACH preambles PR0-PRN, grouped according to associated SSB index, such as SSB indices SSB0-SSB3, as a part of RACH configuration.

In accordance with various aspects of the present disclosure, the UEs 115b and 115c obtain configured PRACH preambles 1002, which include one or more PRACH preambles associated with two or more SSBs. The UEs 115b and 115c determine suitable beams, such as described with respect to FIG. 6, with UE 115b identifying SSB1, received on beam B, as meeting the signal quality threshold, and UE 115c identifying SSB1 and SSB2, received on beams B and C, respectively, as meeting the signal quality threshold. The UE 115b selects a PRACH preamble, PR . . . , from configured PRACH preambles 1002 associated singly with SSB1, and the UE 115c selects a PRACH preamble, PR . . . , from configured PRACH preambles 1002 associated with the set or combination of SSB1 and SSB2. The configured PRACH preambles 1002 include PRACH preambles associated with three SSBs. Therefore, the PRACH preamble, PR . . . , selected by the UE 115c associates with the set or combination of SSB1/2/3. The UEs 115b and 115c transmit the selected PRACH preambles to the network entity 105 in RACH messages 1003 and 1004. The network entity 105 determines a common suitable beam, beam B, by identifying common SSBs indicated in the PRACH preambles included in RACH messages 1003 and 1004.

In a first alternative implementation of the aspect illustrated with respect to the UE 115b in FIG. 10, the RACH configuration messages 1001 further include an indicator 1005a. In this first alternative implementation, the indicator 1005a comprises an integer indicator. When the network entity 105 sets the value of the indicator 1005a1 to 0 (y=0), the UE 115b, upon receipt of the indicator 1005a1 in the RACH configuration messages 1001, disables the capability to indicate more than one suitable beam using a single PRACH preamble. In such case, the UE 103b will select a PRACH preamble from the listing of available PRACH preambles 700 that corresponds to the SSB, SSB1, that meets the signal quality threshold. When the network entity 105 sets the indicator 1005a2 to a positive integer value, illustrated in the present example aspect as 3 (y=3), the UE 115b creates the configured PRACH preambles 1002 with up to y different SSBs per group of PRACH preambles. The UE 115b would then select a PRACH preamble from the configured PRACH preambles 1002 associated singly with beam B.

In a second alternative implementation of the aspect illustrated with respect to the UE 115c in FIG. 10, the RACH configuration messages 1001 further include an enablement indicator 1006a. In this second alternative implementation, the indicator 1006a comprises a Boolean or binary parameter. When the network entity 105 sets the indicator 1006a1 to 0 (B=0), the UE 115c, upon receipt of the enablement indicator 1006a1 in the RACH configuration messages 1001, disables the capability to indicate more than one suitable beam using a single PRACH preamble. In such case, the UE 103c will select a PRACH preamble from the listing of available PRACH preambles 700 associated singly with the SSB2, which it determined met the signal quality threshold. When the network entity 105 sets the indicator 1006a2 to 1 (B=1), the UE 115c enables the capability to indicate more than one suitable beam using a single PRACH preamble. In the second alternative implementation, the UE 115c would obtain the configured PRACH preambles 1002 from the network entity 105 within the RACH configuration messages 1001. The UE 115c would then select a PRACH preamble from the configured preambles 1002 associated with SSB1 and SSB2, which it determined met the signal quality threshold. The UE 115c would select such PRACH preamble, PR . . . , from the set or combination of SSB1/2/3.

FIG. 11 is a block diagram of an example UE 115 that supports preamble-based identification of common beams according to one or more aspects. In some examples, the UE 115 may be configured to perform operations, including the blocks of the process 40 described with reference to FIG. 4. The UE 115 may include one or more chips, systems-on-chips (SoCs), chipsets, packages, components or devices that individually or collectively constitute or comprise a processing system 1100. The processing system 1100 may interface with other components of the UE 115, and may generally process information (such as inputs or signals) received from such other components and output information (such as outputs or signals) to such other components. In some aspects, an example chip may include the processing system 1100, a first interface to output or transmit information and a second interface to receive or obtain information. For example, the first interface may refer to an interface between the processing system 1100 of the chip and a transmission component, for example the antennas 252a-r and the radios 1102a-r, such that the UE 115 may transmit the information output from the chip. In such an example, the second interface may refer to an interface between the processing system 1100 of the chip and a reception component, for example the antennas 252a-r and the radios 1102a-r, such that the UE 115 may receive information that is passed to the processing system. In some such examples, the first interface also may obtain information, such as from the transmission component, and the second interface also may output information, such as to the reception component.

The processing system 1100 of the UE 115 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system 1100 may further include memory circuitry 1101 in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein.

Additionally or alternatively, in some examples, one or more of the processors may be preconfigured to perform various functions or operations described herein without requiring configuration by software. The processing system 1100 may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system 602 include or implement one or more of the modems. The processing system 1100 may further include or be coupled with the multiple radios 1102a-r (collectively “the radio”), multiple RF chains or multiple transceivers, each of which may in turn be coupled with one or more of the multiple antennas 252a-r. In some implementations, one or more processors of the processing system 1100 include or implement one or more of the radios 1102a-r, RF chains or transceivers.

In other implementations, the UE 115 includes the structure, hardware, and components shown and described with reference to the UE 115 of FIG. 2 or 3. For example, the processing system 1100 may correspond to the controller 280, which operates to execute logic or computer instructions stored in the memory circuitry 1101, which may correspond to memory 282, as well as controlling the components of the UE 115 that provide the features and functionality of the UE 115. The UE 115, under control of the processing system 1100, transmits and receives signals via radios 1102a-r and the antennas 252a-r. The radios 1102a-r include various components and hardware, as illustrated in FIG. 2 for the UE 115, including the modulator and demodulators 254a-r , the MIMO detector 256, the receive processor 258, the transmit processor 264, and the TX MIMO processor 266.

As shown, the memory 282 may include multi-direction SSB logic 1103, overlapping PRACH preambles 1104, non-overlapping PRACH preambles 1105, and measurement logic 1106. As noted above with respect to FIG. 3, “overlapping” refers to the PRACH preambles associated with two or more SSBs, while “non-overlapping” refers to the PRACH preambles associated with a single SSB. The multi-direction SSB logic 1103 may be configured to enable the UE 115 to identify PRACH preambles associated with two or more SSBs. The UE 115 stores PRACH preambles indicated by the network entity in overlapping PRACH preambles 1104, for the PRACH preambles associated with two or more SSBs, and the non-overlapping RACH preambles 1105, for the PRACH preambles associated with a single SSB. The measurement logic 1106 may be configured to enable measurement functionality at the UE 115, including measurement functionality for measuring signal quality, such as RSRP, SNR, and the like, as well as internal measurement functionality, such as comparing signal measurements against predetermined thresholds, system requirements, and the like. The UE 115 may receive signals from or transmit signals to one or more network entities, such as the network entity 105 of FIGS. 1-3 or a network entity 105 as illustrated in FIG. 12.

In some implementations, the UE 115 may be configured to perform the process 50 of FIG. 5. To illustrate, the UE 115 may execute, under control of the processing system 1100, the multi-direction SSB logic 1103, the measurement logic 1106, stored in the memory circuitry 1101. The execution environment of the multi-direction SSB logic 1103 and the measurement logic 1106, along with the PRACH preambles stored in memory circuitry 1101 at the overlapping PRACH preambles 1104 and non-overlapping PRACH preambles 1105, provides the functionality to perform at least the operations in blocks 500 and 502. Operations of the antennas 252a-r and radios 1102a-r, under control of the processing system 1100, provide the functionality to perform at least the operations in block 501.

FIG. 12 is a block diagram of an example network entity 105 that supports preamble-based identification of common beams according to one or more aspects. The network entity 105 may be configured to perform operations, including the blocks of the process 40 described with reference to FIG. 4. In some implementations, the network entity 105 includes the structure, hardware, and components shown and described with reference to the network entity 105 and the base station 140 of FIGS. 1-3. For example, the processing system 1200 of the network entity 105 may include the controller 240 (FIG. 2), which operates to execute logic or computer instructions stored in the memory circuitry 1201, which may include the memory 242 (FIG. 2), as well as controlling the components of the network entity 105 that provide the features and functionality of the network entity 105. The network entity 105, under control of the processing system 1200, transmits and receives signals via radios 1201a-t and the antennas 234a-t. The radios 1201a-t include various components and hardware, as illustrated in FIG. 2 for the base station 140, including the modulator and demodulators 232a-t, the transmit processor 220, the TX MIMO processor 230, the MIMO detector 236, and the receive processor 238.

As shown, the memory circuitry 1201 may include multi-direction SSB logic 1203, PRACH preamble configuration logic 1204, and common communication logic 1205. The multi-direction SSB logic 1203 may be configured to enable the network entity 105 to manage the capability to indicate more than one suitable beam using a single PRACH preamble. Within the execution environment of the multi-direction SSB logic 1203, the network entity 105 executes, under control of processing system 1200, the PRACH preamble configuration logic 1204, which configures PRACH preambles including PRACH preambles associated with a single SSB and at least one PRACH preamble associated with two or more SSBs. The common communication logic 1205 may be configured to enable the network entity 105 to identify when common communications exist for multiple served UEs and then to identify common beams to transmit such common communications to the multiple UEs based on common SSBs identified in PRACH preambles received from the multiple UEs. The network entity 105 may receive signals from or transmit signals to one or more UEs, such as the UE 115 of FIGS. 1-3 or the UE 115 of FIG. 11.

In some implementations, the network entity 105 may be configured to perform the process 40 of FIG. 4. To illustrate, the network entity 105 may execute, under control of the processing system 1200, the multi-direction SSB logic 1203 and the PRACH preamble configuration logic 1204, stored in the memory circuitry 1201. The execution environment of the multi-direction SSB logic 1203 and the PRACH preamble configuration logic 1204 provides the functionality to perform at least the operations in block 400. Operations of the antennas 234a-t and radios 1202a-t, under control of the processing system 1200, provide the functionality to perform at least the operations in blocks 401 and 402.

It is noted that one or more blocks (or operations) described with reference to FIGS. 4 and 5 may be combined with one or more blocks (or operations) described with reference to another of the figures. For example, one or more blocks (or operations) of FIG. 4 may be combined with one or more blocks (or operations) of FIG. 6. As another example, one or more blocks associated with FIGS. 4 and 5 may be combined with one or more blocks (or operations) associated with FIG. 1, 2, or 3. Additionally, or alternatively, one or more operations described above with reference to FIG. 1, 2, or 3 may be combined with one or more operations described with reference to FIG. 11 or 12.

In some aspects, techniques for enabling preamble-based identification of common beams may include additional aspects, such as any single aspect or any combination of aspects described below or in connection with one or more other processes or devices described elsewhere herein. In a first aspect, techniques for enabling preamble-based identification of common beams may include a network entity comprising a processing system that includes processor circuitry and memory circuitry that stores code, the processing system configured to cause the network entity to transmit one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSB; transmit the plurality of SSBs on respective beams of the plurality of beams; and receive a RACH message from a first UE that includes a first PRACH preamble from the one or more PRACH preambles, the first PRACH preamble associated with a respective set of two or more SSBs and indicating that each beam associated with each SSB of the respective set of two or more SSBs is acceptable. In some implementations, the apparatus includes a wireless device, such as a base station.

In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communications may include one or more operations described herein with reference to the apparatus.

In a second aspect, alone or in combination with the first aspect, wherein the processing system is further configured to cause the network entity to receive a second RACH message from a second UE that includes a second PRACH preamble from the plurality of PRACH preambles, the second PRACH preamble being associated with a single SSB, of the plurality of SSBs, associated with a single beam, the second PRACH preamble indicating that the single beam is acceptable, the single beam being a same beam as one beam associated with a respective one of the respective set of two or more SSBs associated with the first PRACH preamble; and transmit signaling to the first UE and the second UE using the same beam.

In a third aspect, alone or in combination with the first aspect, wherein the one or more RACH configuration messages include an assigned number value of PRACH preambles to be included in each of one or more sets of PRACH preambles of the one or more PRACH preambles, each set of the one or more sets of PRACH preambles associated with an associated set of two or more SSBs.

In a fourth aspect, alone or in combination with the third aspect, wherein the assigned number value of PRACH preambles includes a different assigned number value of PRACH preambles for each set of the one or more sets of PRACH preambles.

In a fifth aspect, alone or in combination with the first aspect, wherein the one or more RACH configuration messages indicating the plurality of PRACH preambles include an identification of each PRACH preamble of the one or more PRACH preambles.

In a sixth aspect, alone or in combination with the fifth aspect, wherein a number value of PRACH preambles to be included in each of one or more sets of PRACH preambles of the one or more PRACH preambles in the indication is configured by the network entity in accordance with a predefined number value of PRACH preambles, each set of the one or more sets of PRACH preambles associated with an associated set of two or more SSBs.

In a seventh aspect, alone or in combination with the first aspect, wherein the processing system is further configured to cause the network entity to signal an identification of the plurality of SSBs to be transmitted, the one or more RACH configuration messages including a configuration of a plurality of available RACH occasions and an indicator that one or more RACH occasions of the plurality of available RACH occasions support two or more SSB transmissions.

In an eighth aspect, alone or in combination with the first aspect, wherein the one or more RACH configuration messages include a multi-SSB reporting indicator to indicate whether use of the one or more PRACH preambles is enabled or disabled.

In a ninth aspect, alone or in combination with the eighth aspect, wherein the multi-SSB reporting indicator includes one of a Boolean indicator indicating the use of the one or more PRACH preambles is one of enabled or disabled; or an integer indicator indicating a number value of SSB transmissions supported per RACH occasion in accordance with the integer indicator including a positive integer value or disabling use of the one or more PRACH preambles in accordance with the integer indicator having a zero value.

In a tenth aspect, alone or in combination with the first aspect, wherein the processing system is further configured to cause the network entity to transmit a message indicating a RSRP threshold that is different than a cell RSRP threshold associated with a minimum receive power level for a served UE to perform initial access to a cell supported by the network entity.

An eleventh aspect includes a method for wireless communication by a network entity, including transmitting one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs; transmitting the plurality of SSBs on respective beams of the plurality of beams; and receiving a RACH message from a first UE that includes a first PRACH preamble from the one or more PRACH preambles, the first PRACH preamble associated with a respective set of two or more SSBs and indicating that each beam associated with each SSB of the respective set of two or more SSBs is acceptable.

In a twelfth aspect, alone or in combination with the eleventh aspect, further including receiving a second RACH message from a second UE that includes a second PRACH preamble from the plurality of PRACH preambles, the second PRACH preamble being associated with a single SSB, of the plurality of SSBs, associated with a single beam, the second PRACH preamble indicating that the single beam is acceptable, the single beam being a same beam as one beam associated with a respective one of the respective set of two or more SSBs associated with the first PRACH preamble; and transmitting signaling to the first UE and the second UE using the same beam.

In a thirteenth aspect, alone or in combination with the eleventh aspect, wherein the one or more RACH configuration messages include an assigned number value of PRACH preambles to be included in each of one or more sets of PRACH preambles of the one or more PRACH preambles, each set of the one or more sets of PRACH preambles associated with an associated set of two or more SSBs.

In a fourteenth aspect, alone or in combination with the thirteenth aspect, wherein the assigned number value of PRACH preambles includes a different assigned number value of PRACH preambles for each set of the one or more sets of PRACH preambles.

In a fifteenth aspect, alone or in combination with the eleventh aspect, wherein the one or more RACH configuration messages indicating the plurality of PRACH preambles include an identification of each PRACH preamble of the one or more PRACH preambles.

In a sixteenth aspect, alone or in combination with the fifteenth aspect, wherein a number value of PRACH preambles to be included in each of one or more sets of PRACH preambles of the one or more PRACH preambles in the indication is configured by the network entity in accordance with a predefined number value of PRACH preambles, each set of the one or more sets of PRACH preambles associated with an associated set of two or more SSBs.

In a seventeenth aspect, alone or in combination with the eleventh aspect, further including signaling an identification of the plurality of SSBs to be transmitted, the one or more RACH configuration messages including a configuration of a plurality of available RACH occasions and an indicator that one or more RACH occasions of the plurality of available RACH occasions support two or more SSB transmissions.

In an eighteenth aspect, alone or in combination with the eleventh aspect, wherein the one or more RACH configuration messages include a multi-SSB reporting indicator to indicate whether use of the one or more PRACH preambles is enabled or disabled.

In a nineteenth aspect, alone or in combination with the eighteenth aspect, wherein the multi-SSB reporting indicator includes one of a Boolean indicator indicating the use of the one or more PRACH preambles is one of enabled or disabled; or an integer indicator indicating a number value of SSB transmissions supported per RACH occasion in accordance with the integer indicator including a positive integer value or disabling use of the one or more PRACH preambles in accordance with the integer indicator having a zero value.

In a twentieth aspect, alone or in combination with the eleventh aspect, further including transmitting a message indicating a reference signal receive power (RSRP) threshold that is different than a cell RSRP threshold associated with a minimum receive power level for a served UE to perform initial access to a cell supported by the network entity.

A twenty-first aspect includes a network entity configured for wireless communication. The network entity including means for transmitting one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs; means for transmitting the plurality of SSBs on respective beams of the plurality of beams; and means for receiving a RACH message from a first UE that includes a first PRACH preamble from the one or more PRACH preambles, the first PRACH preamble associated with a respective set of two or more SSBs and indicating that each beam associated with each SSB of the respective set of two or more SSBs is acceptable.

In a twenty-second aspect, alone or in combination with the twenty-first aspect, further including means for receiving a second RACH message from a second UE that includes a second PRACH preamble from the plurality of PRACH preambles, the second PRACH preamble being associated with a single SSB, of the plurality of SSBs, associated with a single beam, the second PRACH preamble indicating that the single beam is acceptable, the single beam being a same beam as one beam associated with a respective one of the respective set of two or more SSBs associated with the first PRACH preamble; and means for transmitting signaling to the first UE and the second UE using the same beam.

In a twenty-third aspect, alone or in combination with the twenty-first aspect, wherein the one or more RACH configuration messages include an assigned number value of PRACH preambles to be included in each of one or more sets of PRACH preambles of the one or more PRACH preambles, each set of the one or more sets of PRACH preambles associated with an associated set of two or more SSBs.

In a twenty-fourth aspect, alone or in combination with the twenty-third aspect, wherein the assigned number value of PRACH preambles includes a different assigned number value of PRACH preambles for each set of the one or more sets of PRACH preambles.

In a twenty-fifth aspect, alone or in combination with the twenty-first, wherein the one or more RACH configuration messages indicating the plurality of PRACH preambles include an identification of each PRACH preamble of the one or more PRACH preambles.

In a twenty-sixth aspect, alone or in combination with the twenty-fifth aspect, wherein a number value of PRACH preambles to be included in each of one or more sets of PRACH preambles of the one or more PRACH preambles in the indication is configured by the network entity in accordance with a predefined number value of PRACH preambles, each set of the one or more sets of PRACH preambles associated with an associated set of two or more SSBs.

In a twenty-seventh aspect, alone or in combination with the twenty-first aspect, further including means for signaling an identification of the plurality of SSBs to be transmitted, the one or more RACH configuration messages including a configuration of a plurality of available RACH occasions and an indicator that one or more RACH occasions of the plurality of available RACH occasions support two or more SSB transmissions.

In a twenty-eighth aspect, alone or in combination with the twenty-first aspect, wherein the one or more RACH configuration messages include a multi-SSB reporting indicator to indicate whether use of the one or more PRACH preambles is enabled or disabled.

In a twenty-ninth aspect, alone or in combination with the twenty-eighth aspect, wherein the multi-SSB reporting indicator includes one of a Boolean indicator indicating the use of the one or more PRACH preambles is one of enabled or disabled; or an integer indicator indicating a number value of SSB transmissions supported per RACH occasion in accordance with the integer indicator including a positive integer value or disabling use of the one or more PRACH preambles in accordance with the integer indicator having a zero value.

In a thirtieth aspect, alone or in combination with the twenty-first aspect, further including means for transmitting a message indicating a RSRP threshold that is different than a cell RSRP threshold associated with a minimum receive power level for a served UE to perform initial access to a cell supported by the network entity.

A thirty-first aspect includes a non-transitory computer-readable medium storing instructions. When executed by a processor at a network entity, the instructions cause the processor to perform operations including transmitting one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs; transmitting the plurality of SSBs on respective beams of the plurality of beams; and receiving a RACH message from a first UE that includes a first PRACH preamble from the one or more PRACH preambles, the first PRACH preamble associated with a respective set of two or more SSBs and indicating that each beam associated with each SSB of the respective set of two or more SSBs is acceptable.

In a thirty-second aspect, alone or in combination with the thirty-first aspect, wherein the instructions further cause the processor to perform operations including receiving a second RACH message from a second UE that includes a second PRACH preamble from the plurality of PRACH preambles, the second PRACH preamble being associated with a single SSB, of the plurality of SSBs, associated with a single beam, the second PRACH preamble indicating that the single beam is acceptable, the single beam being a same beam as one beam associated with a respective one of the respective set of two or more SSBs associated with the first PRACH preamble; and transmitting signaling to the first UE and the second UE using the same beam.

In a thirty-third aspect, alone or in combination with the thirty-first aspect, wherein the one or more RACH configuration messages include an assigned number value of PRACH preambles to be included in each of one or more sets of PRACH preambles of the one or more PRACH preambles, each set of the one or more sets of PRACH preambles associated with an associated set of two or more SSBs.

In a thirty-fourth aspect, alone or in combination with the thirty-third aspect, wherein the assigned number value of PRACH preambles includes a different assigned number value of PRACH preambles for each set of the one or more sets of PRACH preambles.

In a thirty-fifth aspect, alone or in combination with the thirty-first aspect, wherein the one or more RACH configuration messages indicating the plurality of PRACH preambles include an identification of each PRACH preamble of the one or more PRACH preambles.

In a thirty-sixth aspect, alone or in combination with the thirty-fifth aspect, wherein a number value of PRACH preambles to be included in each of one or more sets of PRACH preambles of the one or more PRACH preambles in the indication is configured by the network entity in accordance with a predefined number value of PRACH preambles, each set of the one or more sets of PRACH preambles associated with an associated set of two or more SSBs.

In a thirty-seventh aspect, alone or in combination with the thirty-first aspect, wherein the instructions further cause the processor to perform operations including signaling an identification of the plurality of SSBs to be transmitted, the one or more RACH configuration messages including a configuration of a plurality of available RACH occasions and an indicator that one or more RACH occasions of the plurality of available RACH occasions support two or more SSB transmissions.

In a thirty-eighth aspect, alone or in combination with the thirty-first aspect, wherein the one or more RACH configuration messages include a multi-SSB reporting indicator to indicate whether use of the one or more PRACH preambles is enabled or disabled.

In a thirty-ninth aspect, alone or in combination with the thirty-eighth aspect, wherein the multi-SSB reporting indicator includes one of a Boolean indicator indicating the use of the one or more PRACH preambles is one of enabled or disabled; or an integer indicator indicating a number value of SSB transmissions supported per RACH occasion in accordance with the integer indicator including a positive integer value or disabling use of the one or more PRACH preambles in accordance with the integer indicator having a zero value.

In a fortieth aspect, alone or in combination with the thirty-first aspect, wherein the instructions further cause the processor to perform operations including transmitting a message indicating a RSRP threshold that is different than a cell RSRP threshold associated with a minimum receive power level for a served UE to perform initial access to a cell supported by the network entity.

In one or more aspects, techniques for supporting preamble-based identification of common beams may include additional aspects, such as any single aspect or any combination of aspects described below or in connection with one or more other processes or devices described elsewhere herein. In a forty-first aspect, supporting preamble-based identification of common beams may include a UE comprising a processing system that includes processor circuitry and memory circuitry that stores code, the processing system configured to cause the UE to receive one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs; receive at least some of the plurality of SSBs on respective beams of the plurality of beams; and transmit a RACH message that includes a first PRACH preamble from the first set of one or more PRACH preambles associated with a respective set of two or more SSBs, the first PRACH preamble indicating that each beam associated with each SSB of the respective set of two or more SSBs is acceptable. Additionally, the apparatus may perform or operate according to one or more aspects as described below. In some examples, the techniques in the forty-first aspect may be implemented in a method or process. In some other examples, the techniques of the first aspect may be implemented in a wireless communication device such as a UE or a component of a UE.

In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein.

In a forty-second aspect, alone or in combination with the forty-first aspect, wherein the processing system is further configured to cause the UE to measure a RSRP of each SSB of the at least some of the plurality of SSBs received by the UE, the first PRACH preamble selected in accordance with the RSRP of the respective set of two or more SSBs satisfying an RSRP threshold indicating that each beam associated with each SSB of the respective set of two or more SSBs is acceptable for communication by the UE.

In a forty-third aspect, alone or in combination with the forty-second aspect, wherein the RSRP threshold is different than a cell RSRP threshold associated with a minimum receive power level for the UE to perform initial access to a cell.

In a forty-fourth aspect, alone or in combination with the forty-first aspect, wherein the one or more RACH configuration messages includes an assigned number value of PRACH preambles to be included in each of one or more sets of PRACH preambles of the one or more PRACH preambles, each set of the one or more sets of PRACH preambles associated with an associated set of two or more SSBs.

In a forty-fifth aspect, alone or in combination with the forty-fourth aspect, wherein the assigned number value of PRACH preambles includes a different assigned number value of PRACH preambles for each set of the one or more sets of PRACH preambles.

In a forty-sixth aspect, alone or in combination with the forty-first aspect, wherein the one or more RACH configuration messages indicating the plurality of PRACH preambles includes an identification of each PRACH preamble of the one or more PRACH preambles.

In a forty-seventh aspect, alone or in combination with the forty-first aspect, wherein the processing system is further configured to cause the UE to obtain an identification of the plurality of SSBs to be transmitted, the one or more RACH configuration messages including a configuration of a plurality of available RACH occasions and an indicator that one or more RACH occasions of the plurality of available RACH occasions support two or more SSB transmissions; identify, in response to the indicator, a plurality of combinations of SSB indices of a plurality of SSB indices respectively associated with the plurality of SSBs, each combination of SSB indices of the plurality of combinations of SSB indices including two or more SSB indices associated with the two or more SSBs of the plurality of SSBs to be transmitted; map each SSB index associated with each SSB of the plurality of SSBs to be transmitted to an associated RACH occasion of a first set of RACH occasions of the plurality of available RACH occasions; and map each combination of SSB indices of the plurality of combinations of SSB indices to an associated remaining RACH occasion of a remaining set of RACH occasions of the plurality of available RACH occasions.

In a forty-eighth aspect, alone or in combination with the forty-first aspect, wherein the one or more RACH configuration messages include a multi-SSB reporting indicator to indicate whether use of the one or more PRACH preambles is enabled or disabled.

In a forty-ninth aspect, alone or in combination with the forty-eighth aspect, wherein the multi-SSB reporting indicator includes one of a Boolean indicator indicating the use of the one or more PRACH preambles is one of enabled or disabled; or an integer indicator indicating a number value of SSB transmissions supported per RACH occasion in accordance with the integer indicator including a positive integer value or disabling use of the one or more PRACH preambles in accordance with the integer indicator having a zero value.

In a fiftieth aspect, alone or in combination with the forty-first aspect, wherein the processing system is further configured to cause the UE to monitor for signaling from a network entity on each beam associated with the each SSB of the respective set of two or more SSBs associated with the first PRACH preamble.

A fifty-first aspect includes a method for wireless communication by a UE includes receiving one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs; receiving at least some of the plurality of SSBs on respective beams of the plurality of beams; and transmitting a RACH message that includes a first PRACH preamble from the first set of one or more PRACH preambles associated with a respective set of two or more SSBs, the first PRACH preamble indicating that each beam associated with each SSB of the respective set of two or more SSBs is acceptable.

In a fifty-second aspect, alone or in combination with the fifty-first aspect, further including measuring a RSRP of each SSB of the at least some of the plurality of SSBs received by the UE, the first PRACH preamble selected in accordance with the RSRP of the respective set of two or more SSBs satisfying an RSRP threshold indicating that each beam associated with each SSB of the respective set of two or more SSBs is acceptable for communication by the UE.

In a fifty-third aspect, alone or in combination with the fifty-second aspect, wherein the RSRP threshold is different than a cell RSRP threshold associated with a minimum receive power level for the UE to perform initial access to a cell.

In a fifty-fourth aspect, alone or in combination with the fifty-first aspect, wherein the one or more RACH configuration messages includes an assigned number value of PRACH preambles to be included in each of one or more sets of PRACH preambles of the one or more PRACH preambles, each set of the one or more sets of PRACH preambles associated with an associated set of two or more SSBs.

In a fifty-fifth aspect, alone or in combination with the fifty-fourth aspect, wherein the assigned number value of PRACH preambles includes a different assigned number value of PRACH preambles for each set of the one or more sets of PRACH preambles.

In a fifty-sixth aspect, alone or in combination with the fifty-first aspect, wherein the one or more RACH configuration messages indicating the plurality of PRACH preambles includes an identification of each PRACH preamble of the one or more PRACH preambles.

In a fifty-seventh aspect, alone or in combination with the fifty-first aspect, further including obtaining an identification of the plurality of SSBs to be transmitted, the one or more RACH configuration messages including a configuration of a plurality of available RACH occasions and an indicator that one or more RACH occasions of the plurality of available RACH occasions support two or more SSB transmissions; identifying, in response to the indicator, a plurality of combinations of SSB indices of a plurality of SSB indices respectively associated with the plurality of SSBs, each combination of SSB indices of the plurality of combinations of SSB indices including two or more SSB indices associated with the two or more SSBs of the plurality of SSBs to be transmitted; mapping each SSB index associated with each SSB of the plurality of SSBs to be transmitted to an associated RACH occasion of a first set of RACH occasions of the plurality of available RACH occasions; and mapping each combination of SSB indices of the plurality of combinations of SSB indices to an associated remaining RACH occasion of a remaining set of RACH occasions of the plurality of available RACH occasions.

In a fifty-eighth aspect, alone or in combination with the fifty-first aspect, wherein the one or more RACH configuration messages include a multi-SSB reporting indicator to indicate whether use of the one or more PRACH preambles is enabled or disabled.

In a fifty-ninth aspect, alone or in combination with the fifty-eighth aspect, wherein the multi-SSB reporting indicator includes one of a Boolean indicator indicating the use of the one or more PRACH preambles is one of enabled or disabled; or an integer indicator indicating a number value of SSB transmissions supported per RACH occasion in accordance with the integer indicator including a positive integer value or disabling use of the one or more PRACH preambles in accordance with the integer indicator having a zero value.

In a sixtieth aspect, alone or in combination with the fifty-first aspect, further including monitoring for signaling from a network entity on each beam associated with the each SSB of the respective set of two or more SSBs associated with the first PRACH preamble.

A sixty-first aspect includes a UE configured for wireless communication. The UE includes means for receiving one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs; means for receiving at least some of the plurality of SSBs on respective beams of the plurality of beams; and means for transmitting a RACH message that includes a first PRACH preamble from the first set of one or more PRACH preambles associated with a respective set of two or more SSBs, the first PRACH preamble indicating that each beam associated with each SSB of the respective set of two or more SSBs is acceptable.

In a sixty-second aspect, alone or in combination with the sixty-first aspect, further including means for measuring a RSRP of each SSB of the at least some of the plurality of SSBs received by the UE, the first PRACH preamble selected in accordance with the RSRP of the respective set of two or more SSBs satisfying an RSRP threshold indicating that each beam associated with each SSB of the respective set of two or more SSBs is acceptable for communication by the UE.

In a sixty-third aspect, alone or in combination with the sixty-second aspect, wherein the RSRP threshold is different than a cell RSRP threshold associated with a minimum receive power level for the UE to perform initial access to a cell.

In a sixty-fourth aspect, alone or in combination with the sixty-first aspect, wherein the one or more RACH configuration messages includes an assigned number value of PRACH preambles to be included in each of one or more sets of PRACH preambles of the one or more PRACH preambles, each set of the one or more sets of PRACH preambles associated with an associated set of two or more SSBs.

In a sixty-fifth aspect, alone or in combination with the sixty-fourth aspect, wherein the assigned number value of PRACH preambles includes a different assigned number value of PRACH preambles for each set of the one or more sets of PRACH preambles.

In a sixty-sixth aspect, alone or in combination with the sixty-first aspect, wherein the one or more RACH configuration messages indicating the plurality of PRACH preambles includes an identification of each PRACH preamble of the one or more PRACH preambles.

In a sixty-seventh aspect, alone or in combination with the sixty-first aspect, further including means for obtaining an identification of the plurality of SSBs to be transmitted, the one or more RACH configuration messages including a configuration of a plurality of available RACH occasions and an indicator that one or more RACH occasions of the plurality of available RACH occasions support two or more SSB transmissions; means for identifying, in response to the indicator, a plurality of combinations of SSB indices of a plurality of SSB indices respectively associated with the plurality of SSBs, each combination of SSB indices of the plurality of combinations of SSB indices including two or more SSB indices associated with the two or more SSBs of the plurality of SSBs to be transmitted; means for mapping each SSB index associated with each SSB of the plurality of SSBs to be transmitted to an associated RACH occasion of a first set of RACH occasions of the plurality of available RACH occasions; and means for mapping each combination of SSB indices of the plurality of combinations of SSB indices to an associated remaining RACH occasion of a remaining set of RACH occasions of the plurality of available RACH occasions.

In a sixty-eighth aspect, alone or in combination with the sixty-first aspect, wherein the one or more RACH configuration messages include a multi-SSB reporting indicator to indicate whether use of the one or more PRACH preambles is enabled or disabled.

In a sixty-ninth aspect, alone or in combination with the sixty-eighth aspect, wherein the multi-SSB reporting indicator includes one of a Boolean indicator indicating the use of the one or more PRACH preambles is one of enabled or disabled; or an integer indicator indicating a number value of SSB transmissions supported per RACH occasion in accordance with the integer indicator including a positive integer value or disabling use of the one or more PRACH preambles in accordance with the integer indicator having a zero value.

In a seventieth aspect, alone or in combination with the sixty-first aspect, further including means for monitoring for signaling from a network entity on each beam associated with the each SSB of the respective set of two or more SSBs associated with the first PRACH preamble.

A seventy-first aspect includes a non-transitory computer-readable medium storing instructions. When executed by a processor at a UE, the instructions cause the processor to perform operations including receiving one or more RACH configuration messages indicating a plurality of PRACH preambles associated with a plurality of SSBs, each SSB of the plurality of SSBs being associated with a respective beam of a plurality of beams, one or more PRACH preambles of the plurality of PRACH preambles each being associated with two or more SSBs of the plurality of SSBs; receiving at least some of the plurality of SSBs on respective beams of the plurality of beams; and transmitting a RACH message that includes a first PRACH preamble from the first set of one or more PRACH preambles associated with a respective set of two or more SSBs, the first PRACH preamble indicating that each beam associated with each SSB of the respective set of two or more SSBs is acceptable.

In a seventy-second aspect, alone or in combination with the seventy-first aspect, wherein the instructions further cause the processor to perform operations including measuring a RSRP of each SSB of the at least some of the plurality of SSBs received by the UE, the first PRACH preamble selected in accordance with the RSRP of the respective set of two or more SSBs satisfying an RSRP threshold indicating that each beam associated with each SSB of the respective set of two or more SSBs is acceptable for communication by the UE.

In a seventy-third aspect, alone or in combination with the seventy-second aspect, wherein the RSRP threshold is different than a cell RSRP threshold associated with a minimum receive power level for the UE to perform initial access to a cell.

In a seventy-fourth aspect, alone or in combination with the seventy-first aspect, wherein the one or more RACH configuration messages includes an assigned number value of PRACH preambles to be included in each of one or more sets of PRACH preambles of the one or more PRACH preambles, each set of the one or more sets of PRACH preambles associated with an associated set of two or more SSBs.

In a seventy-fifth aspect, alone or in combination with the seventy-fourth aspect, wherein the assigned number value of PRACH preambles includes a different assigned number value of PRACH preambles for each set of the one or more sets of PRACH preambles.

In a seventy-sixth aspect, alone or in combination with the seventy-first aspect, wherein the one or more RACH configuration messages indicating the plurality of PRACH preambles includes an identification of each PRACH preamble of the one or more PRACH preambles.

In a seventy-seventh aspect, alone or in combination with the seventy-first aspect, wherein the instructions further cause the processor to perform operations including obtaining an identification of the plurality of SSBs to be transmitted, the one or more RACH configuration messages including a configuration of a plurality of available RACH occasions and an indicator that one or more RACH occasions of the plurality of available RACH occasions support two or more SSB transmissions; identifying, in response to the indicator, a plurality of combinations of SSB indices of a plurality of SSB indices respectively associated with the plurality of SSBs, each combination of SSB indices of the plurality of combinations of SSB indices including two or more SSB indices associated with the two or more SSBs of the plurality of SSBs to be transmitted; mapping each SSB index associated with each SSB of the plurality of SSBs to be transmitted to an associated RACH occasion of a first set of RACH occasions of the plurality of available RACH occasions; and mapping each combination of SSB indices of the plurality of combinations of SSB indices to an associated remaining RACH occasion of a remaining set of RACH occasions of the plurality of available RACH occasions.

In a seventy-eighth aspect, alone or in combination with the seventy-first aspect, wherein the one or more RACH configuration messages include a multi-SSB reporting indicator to indicate whether use of the one or more PRACH preambles is enabled or disabled.

In a seventy-ninth aspect, alone or in combination with the seventy-eighth aspect, wherein the multi-SSB reporting indicator includes one of a Boolean indicator indicating the use of the one or more PRACH preambles is one of enabled or disabled; or an integer indicator indicating a number value of SSB transmissions supported per RACH occasion in accordance with the integer indicator including a positive integer value or disabling use of the one or more PRACH preambles in accordance with the integer indicator having a zero value.

In an eightieth aspect, alone or in combination with the seventy-first aspect, wherein the instructions further cause the processor to perform operations including monitoring for signaling from a network entity on each beam associated with the each SSB of the respective set of two or more SSBs associated with the first PRACH preamble.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-12 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A network entity, comprising:
a processing system that includes processor circuitry and memory circuitry that stores code, the processing system configured to cause the network entity to:
transmit one or more random access channel (RACH) configuration messages indicating a plurality of physical RACH (PRACH) preambles associated with a plurality of synchronization signal blocks (SSBs), each SSB of the plurality of SSBs being associated with a respective beam of a plurality of beams, one or more PRACH preambles of the plurality of PRACH preambles each being associated with two or more SSBs of the plurality of SSBs;
transmit the plurality of SSBs on respective beams of the plurality of beams; and
receive a RACH message from a first user equipment (UE) that includes a first PRACH preamble from the one or more PRACH preambles, the first PRACH preamble associated with a respective set of two or more SSBs and indicating that each beam associated with each SSB of the respective set of two or more SSBs is acceptable.

2. The network entity of claim 1, wherein the processing system is further configured to cause the network entity to:
receive a second RACH message from a second UE that includes a second PRACH preamble from the plurality of PRACH preambles, the second PRACH preamble being associated with a single SSB, of the plurality of SSBs, associated with a single beam, the second PRACH preamble indicating that the single beam is acceptable, the single beam being a same beam as one beam associated with a respective one of the respective set of two or more SSBs associated with the first PRACH preamble; and
transmit signaling to the first UE and the second UE using the same beam.

3. The network entity of claim 1, wherein the one or more RACH configuration messages include an assigned number value of PRACH preambles to be included in each of one or more sets of PRACH preambles of the one or more PRACH preambles, each set of the one or more sets of PRACH preambles associated with an associated set of two or more SSBs.

4. The network entity of claim 3, wherein the assigned number value of PRACH preambles includes a different assigned number value of PRACH preambles for each set of the one or more sets of PRACH preambles.

5. The network entity of claim 1, wherein the one or more RACH configuration messages indicating the plurality of PRACH preambles include an identification of each PRACH preamble of the one or more PRACH preambles.

6. The network entity of claim 5, wherein a number value of PRACH preambles to be included in each of one or more sets of PRACH preambles of the one or more PRACH preambles in the indication is configured by the network entity in accordance with a predefined number value of PRACH preambles, each set of the one or more sets of PRACH preambles associated with an associated set of two or more SSBs.

7. The network entity of claim 1, wherein the processing system is further configured to cause the network entity to:
signal an identification of the plurality of SSBs to be transmitted, the one or more RACH configuration messages including a configuration of a plurality of available RACH occasions and an indicator that one or more RACH occasions of the plurality of available RACH occasions support two or more SSB transmissions.

8. The network entity of claim 1, wherein the one or more RACH configuration messages include a multi-SSB reporting indicator to indicate whether use of the one or more PRACH preambles is enabled or disabled.

9. The network entity of claim 8, wherein the multi-SSB reporting indicator includes one of:
a Boolean indicator indicating the use of the one or more PRACH preambles is one of enabled or disabled; or
an integer indicator indicating a number value of SSB transmissions supported per RACH occasion in accordance with the integer indicator including a positive integer value or disabling use of the one or more PRACH preambles in accordance with the integer indicator having a zero value.

10. The network entity of claim 1, wherein the processing system is further configured to cause the network entity to:
transmit a message indicating a reference signal receive power (RSRP) threshold that is different than a cell RSRP threshold associated with a minimum receive power level for a served UE to perform initial access to a cell supported by the network entity.

11. A user equipment (UE), comprising:
a processing system that includes processor circuitry and memory circuitry that stores code, the processing system configured to cause the UE to:
receive one or more random access channel (RACH) configuration messages indicating a plurality of physical RACH (PRACH) preambles associated with a plurality of synchronization signal blocks (SSBs), each SSB of the plurality of SSBs being associated with a respective beam of a plurality of beams, one or more PRACH preambles of the plurality of PRACH preambles each being associated with two or more SSBs of the plurality of SSBs;
receive at least some of the plurality of SSBs on respective beams of the plurality of beams; and
transmit a RACH message that includes a first PRACH preamble from the first set of one or more PRACH preambles associated with a respective set of two or more SSBs, the first PRACH preamble indicating that each beam associated with each SSB of the respective set of two or more SSBs is acceptable.

12. The UE of claim 11, wherein the processing system is further configured to cause the UE to:
measure a reference signal receive power (RSRP) of each SSB of the at least some of the plurality of SSBs received by the UE, the first PRACH preamble selected in accordance with the RSRP of the respective set of two or more SSBs satisfying an RSRP threshold indicating that each beam associated with each SSB of the respective set of two or more SSBs is acceptable for communication by the UE.

13. The UE of claim 12, wherein the RSRP threshold is different than a cell RSRP threshold associated with a minimum receive power level for the UE to perform initial access to a cell.

14. The UE of claim 11, wherein the one or more RACH configuration messages includes an assigned number value of PRACH preambles to be included in each of one or more sets of PRACH preambles of the one or more PRACH preambles, each set of the one or more sets of PRACH preambles associated with an associated set of two or more SSBs.

15. The UE of claim 14, wherein the assigned number value of PRACH preambles includes a different assigned number value of PRACH preambles for each set of the one or more sets of PRACH preambles.

16. The UE of claim 11, wherein the one or more RACH configuration messages indicating the plurality of PRACH preambles includes an identification of each PRACH preamble of the one or more PRACH preambles.

17. The UE of claim 11, wherein the processing system is further configured to cause the UE to:
obtain an identification of the plurality of SSBs to be transmitted, the one or more RACH configuration messages including a configuration of a plurality of available RACH occasions and an indicator that one or more RACH occasions of the plurality of available RACH occasions support two or more SSB transmissions;
identify, in response to the indicator, a plurality of combinations of SSB indices of a plurality of SSB indices respectively associated with the plurality of SSBs, each combination of SSB indices of the plurality of combinations of SSB indices including two or more SSB indices associated with the two or more SSBs of the plurality of SSBs to be transmitted;
map each SSB index associated with each SSB of the plurality of SSBs to be transmitted to an associated RACH occasion of a first set of RACH occasions of the plurality of available RACH occasions; and
map each combination of SSB indices of the plurality of combinations of SSB indices to an associated remaining RACH occasion of a remaining set of RACH occasions of the plurality of available RACH occasions.

18. The UE of claim 11, wherein the one or more RACH configuration messages include a multi-SSB reporting indicator to indicate whether use of the one or more PRACH preambles is enabled or disabled.

19. The UE of claim 18, wherein the multi-SSB reporting indicator includes one of:
a Boolean indicator indicating the use of the one or more PRACH preambles is one of enabled or disabled; or
an integer indicator indicating a number value of SSB transmissions supported per RACH occasion in accordance with the integer indicator including a positive integer value or disabling use of the one or more PRACH preambles in accordance with the integer indicator having a zero value.

20. The UE of claim 11, wherein the processing system is further configured to cause the UE to:
monitor for signaling from a network entity on each beam associated with the each SSB of the respective set of two or more SSBs associated with the first PRACH preamble.

21. A method for wireless communication by a network entity, comprising:
transmitting one or more random access channel (RACH) configuration messages indicating a plurality of physical RACH (PRACH) preambles associated with a plurality of synchronization signal blocks (SSBs), each SSB of the plurality of SSBs being associated with a respective beam of a plurality of beams, one or more PRACH preambles of the plurality of PRACH preambles each being associated with two or more SSBs of the plurality of SSBs;
transmitting the plurality of SSBs on respective beams of the plurality of beams; and
receiving a RACH message from a first user equipment (UE) that includes a first PRACH preamble from the one or more PRACH preambles, the first PRACH preamble associated with a respective set of two or more SSBs and indicating that each beam associated with each SSB of the respective set of two or more SSBs is acceptable.

22. The method of claim 21, further including:
receiving a second RACH message from a second UE that includes a second PRACH preamble from the plurality of PRACH preambles, the second PRACH preamble being associated with a single SSB, of the plurality of SSBs, associated with a single beam, the second PRACH preamble indicating that the single beam is acceptable, the single beam being a same beam as one beam associated with a respective one of the respective set of two or more SSBs associated with the first PRACH preamble; and
transmitting signaling to the first UE and the second UE using the same beam.

23. The method of claim 21, wherein the one or more RACH configuration messages include an assigned number value of PRACH preambles to be included in each of one or more sets of PRACH preambles of the one or more PRACH preambles, each set of the one or more sets of PRACH preambles associated with an associated set of two or more SSBs.

24. The method of claim 21, wherein the one or more RACH configuration messages indicating the plurality of PRACH preambles include an identification of each PRACH preamble of the one or more PRACH preambles.

25. The method of claim 21, further including:
signaling an identification of the plurality of SSBs to be transmitted, the one or more RACH configuration messages including a configuration of a plurality of available RACH occasions and an indicator that one or more RACH occasions of the plurality of available RACH occasions support two or more SSB transmissions.

26. The method of claim 21, wherein the one or more RACH configuration messages include a multi-SSB reporting indicator to indicate whether use of the one or more PRACH preambles is enabled or disabled and wherein the multi-SSB reporting indicator includes one of:
a Boolean indicator indicating the use of the one or more PRACH preambles is one of enabled or disabled; or
an integer indicator indicating a number value of SSB transmissions supported per RACH occasion in accordance with the integer indicator including a positive integer value or disabling use of the one or more PRACH preambles in accordance with the integer indicator having a zero value.

27. A method for wireless communication by a user equipment (UE), comprising:
receiving one or more random access channel (RACH) configuration messages indicating a plurality of physical RACH (PRACH) preambles associated with a plurality of synchronization signal blocks (SSBs), each SSB of the plurality of SSBs being associated with a respective beam of a plurality of beams, one or more PRACH preambles of the plurality of PRACH preambles each being associated with two or more SSBs of the plurality of SSBs;
receiving at least some of the plurality of SSBs on respective beams of the plurality of beams; and
transmitting a RACH message that includes a first PRACH preamble from the first set of one or more PRACH preambles associated with a respective set of two or more SSBs, the first PRACH preamble indicating that each beam associated with each SSB of the respective set of two or more SSBs is acceptable.

28. The method of claim 27, further including:
measuring a reference signal receive power (RSRP) of each SSB of the at least some of the plurality of SSBs received by the UE, the first PRACH preamble selected in accordance with the RSRP of the respective set of two or more SSBs satisfying an RSRP threshold indicating that each beam associated with each SSB of the respective set of two or more SSBs is acceptable for communication by the UE.

29. The method of claim 27, further including:
obtaining an identification of the plurality of SSBs to be transmitted, the one or more RACH configuration messages including a configuration of a plurality of available RACH occasions and an indicator that one or more RACH occasions of the plurality of available RACH occasions support two or more SSB transmissions;
identifying, in response to the indicator, a plurality of combinations of SSB indices of a plurality of SSB indices respectively associated with the plurality of SSBs, each combination of SSB indices of the plurality of combinations of SSB indices including two or more SSB indices associated with the two or more SSBs of the plurality of SSBs to be transmitted;
mapping each SSB index associated with each SSB of the plurality of SSBs to be transmitted to an associated RACH occasion of a first set of RACH occasions of the plurality of available RACH occasions; and
mapping each combination of SSB indices of the plurality of combinations of SSB indices to an associated remaining RACH occasion of a remaining set of RACH occasions of the plurality of available RACH occasions.

30. The method of claim 27, further including:
monitoring for signaling from a network entity on each beam associated with the each SSB of the respective set of two or more SSBs associated with the first PRACH preamble.
